(19) United States
(12) Patent Application Publication
(10) Pub. No.: US 2009/0084814 A1
(43) Pub. Date: Apr. 2, 2009

(54) Closure with liner piercing movable spout

(75) Inventors: John Wisniewski, Wauwatosa, WI (US); Travis J. Hoepner, Mukwonago, WI (US)

Correspondence Address: WOOD, PHILLIPS, KATZ, CLARK & MORTIMER, 500 W. MADISON STREET, SUITE 3800, CHICAGO, IL, 60661, US

(73) Assignee: SEAQUIST CLOSURES L.L.C..

(21) Appl. No.: 11/906,367

(22) Filed: Oct. 2, 2007

(51) Int. Cl. B67D 5/00; B65D 35/38; B67D 5/06; B67D 3/00

(52) U.S. Cl. 222/83; 222/494; 222/536; 222/537

(57) ABSTRACT

A dispensing closure system is provided for a container that has an opening wherein a membrane is interposed between the container opening and the dispensing closure system. The system includes a body for extending from the container at the opening. The system includes a movable spout that (1) has a dispensing opening at one end, (2) has a piercing edge at the other end, and (3) is mounted in the body for pivoting the movement between (a) a non-dispensing position in which the piercing edge is above the membrane to locate the spout dispensing opening at a first, non-dispensing location, and (b) a dispensing position in which (i) the piercing edge can pierce the membrane, and (ii) the spout projects outwardly from the body to locate the spout dispensing opening at a location that is further outwardly than the non-dispensing location of the spout dispensing opening.

### TECHNICAL FIELD

This invention relates to container closures for dispensing a fluent substance. The invention is more particularly related to a dispensing closure system for use with a container wherein a membrane is interposed between the container and the dispensing closure system.

### BACKGROUND OF THE INVENTION AND TECHNICAL PROBLEMS POSED BY THE PRIOR ART

Fluent materials, including liquids, creams, powders, etc., may be conventionally packaged in a container having a dispensing closure which includes a container cover defining a plurality of dispensing apertures or openings. A solid cap or lid is typically provided for being releasably secured to the cover for occluding the dispensing openings when the container is not in use. This prevents spillage if the container is dropped or tipped over. The cap may also help keep the contents fresh and may reduce the ingress of contaminants. Such closures can be particularly suitable for containers of household cleaners, floor polish, and the like.

A variety of packages, including dispensing containers, have been developed for various products which are in liquid or powder form (e.g., shampoo, lotion, cosmetic powder, etc.). One type of closure for these kinds of containers includes a flexible, self-closing, slit-type dispensing valve mounted over the container opening. The valve has a slit or slits which define a normally closed orifice that opens to permit flow therethrough in response to increased pressure within the container when the container is squeezed. The valve automatically closes to shut off flow therethrough upon removal of the increased pressure.

Designs of closures using such valves are illustrated in the U.S. Pat. No. 5,271,531, No. 5,927,566, and No. 5,934,512. Typically, the closure includes a base mounted on the container neck to define a seat for receiving the valve and includes a retaining ring or housing structure for holding the valve on the seat in the base. See, for example, U.S. Pat. No. 6,269,986 and No. 6,616,016.

The closure can be provided with a hinged lid for covering the valve during shipping or when the container is packed for travel (or when the container is otherwise not in use). See, for example, FIGS. 31-34 of U.S. Pat. No. 5,271,531. The lid can keep the valve clean and/or protect the valve from damage.

U.S. Pat. No. 5,839,626 discloses a closure having a valve from which a powder is discharged through a perforated dispensing baffle to produce a desirable dispersed distribution pattern of fine powder (e.g., cosmetic powder).

The inventors of the present invention have discovered a novel closure system for dispensing a fluent product, including liquid, wherein the closure system includes advantageous features not heretofore taught or contemplated by the prior art.

### SUMMARY OF THE INVENTION

According to the present invention, an improved dispensing closure system is provided for a container that has an opening to the container interior where a fluent substance may be stored. A membrane is initially interposed between the container and the dispensing closure system. For example, the membrane can be sealed across the top of the container opening and/or across the interior of the dispensing closure system to occlude the container opening. Depending upon the application, the dispensing closure system may also include a lid. The dispensing closure system is especially suitable for use in dispensing a liquid.

The dispensing closure system includes a body for extending from the container at the container opening. The closure system also includes a spout that (1) has a dispensing opening at one end, (2) has a piercing edge at the other end, and (3) is mounted in the body for pivoting movement between (a) a non-dispensing position in which the piercing edge is above the membrane and the dispensing opening is at a non-dispensing location, and (b) a dispensing position in which (i) the piercing edge can pierce the membrane, and (ii) the spout projects outwardly from the body to locate the spout dispensing opening at a dispensing location that is further outwardly than the non-dispensing location of the spout dispensing opening. In the preferred embodiment, the closure system may also employ a dispensing valve in the spout.

A preferred form of the inventive dispensing closure system does not require the use of a reclosable lid to prevent spillage if the container is inadvertently tipped over, and the system eliminates or minimizes contaminant ingress even if no lid is placed on the container.

In the preferred form, as well as other forms, of the invention, the dispensing closure system accommodates the use of the membrane, such as a conventional liner. The inventive dispensing closure system permits the user to conveniently open the membrane (such as a conventional liner) by piercing it without having to manipulate the package so as to first expose the membrane and without requiring removal of the membrane per se. The membrane, after it is pierced, can then remain on the container in the system so that it does not present a litter problem or choking problem for children.

The dispensing closure system inhibits tampering with the package, and provides evidence of tampering if the membrane has been pierced before the intended first user receives the package.

The dispensing closure system components can optionally be designed for easily accommodating the assembly of the components during manufacture of the closure system.

The dispensing closure system can optionally be provided with a design that accommodates efficient, high quality, large volume manufacturing techniques with a reduced product reject rate.

The dispensing closure system can optionally be designed to accommodate its use with a variety of conventional or special containers having a variety of conventional or special container finishes, including conventional threaded, or snap-fit, attachment configurations.

Numerous other advantages and features of the present invention will become readily apparent from the following detailed description of the invention, from the claims, and from the accompanying drawings.

### BRIEF DESCRIPTION OF THE DRAWINGS

In the accompanying drawings forming part of the specification, in which like numerals are employed to designate like parts throughout the same,

FIG. 1 is a fragmentary, isometric view of a first embodiment of the closure system of the present invention in the form of a separate dispensing closure according to a preferred use of the invention, and the closure is shown installed on a container with the closure lid closed;

FIG. 2 is a fragmentary, isometric view of the closure shown with the lid opened;

FIG. 3 is a fragmentary, isometric view similar to FIG. 2, but in FIG. 3 the spout is raised to the dispensing position;

FIG. 4 is a fragmentary, exploded, side elevational view of the components shown in FIG. 2;

FIG. 5 is a fragmentary, exploded, isometric view of the components shown in FIG. 3;

FIG. 6 is a top, plan view of the closed closure shown in FIG. 1, but FIG. 6; shows the closed closure before installation on the container;

FIG. 7 is a cross-sectional view taken generally along the plan 7-7 in FIG. 6;

FIG. 8 is a bottom view of the closure shown in FIG. 6;

FIG. 9 is a top, plan view of the closure shown in FIG. 3;

FIG. 10 is a fragmentary, cross-sectional view taken generally along plane 10-10 in FIG. 9;

FIG. 11 is a fragmentary, cross-sectional view taken generally along the plane 11-11 in FIG. 9;

FIG. 12 is a cross-sectional view taken along plane 12-12 in FIG. 10;

FIG. 13 is an isometric view of the closure body with the lid open, but without the spout (and its internal components) installed;

FIG. 14 is a top, plan view of the closure body shown in FIG. 13;

FIG. 15 is a cross-sectional view taken generally along the plane 15-15 in FIG. 14;

FIG. 16 is a bottom view of the closure body shown in FIG. 15;

FIG. 17 is an isometric view of the spout in the closed position orientation that it has in FIGS. 2 and 4, but in FIG. 17 the spout is shown without the valve and retainer installed inside it;

FIG. 18 is an isometric view of the spout rotated about its longitudinal axis 180 degrees from the position shown in FIG. 17;

FIG. 19 is a top, plan view of the spout relative to the position shown in FIG. 17;

FIG. 20 is a cross-sectional view taken generally along the plane 20-20 in FIG. 19;

FIG. 21 is a bottom view of the spout shown in FIG. 20;

FIG. 22 is a top, plan view of the valve prior to installation in the spout;

FIG. 23 is a side, elevational view of the valve shown in FIG. 22;

FIG. 24 is a fragmentary, cross-sectional view similar to FIG. 10, but FIG. 24 shows the closure inverted and the valve in a dispensing mode of operation;

FIG. 25 is a fragmentary, isometric view of a second embodiment of the closure system of the present invention in the form of a separate dispensing closure according to one preferred use of the invention, and the closure is shown installed on a container with the closure lid closed;

FIG. 26 is a fragmentary, isometric view of the second embodiment of the closure shown with the lid opened;

FIG. 27 is a fragmentary, isometric view similar to FIG. 6, but in FIG. 27 the spout is raised to the dispensing position;

FIG. 28 is a cross-sectional view taken generally along the plane 28-28 in FIG. 25;

FIG. 29 is a view like FIG. 28, but in FIG. 29 the lid is shown in the opened condition corresponding to FIG. 26;

FIG. 30 is a view similar to FIG. 29, but in FIG. 30 the spout is shown in the raised dispensing position corresponding to FIG. 27;

FIG. 31 is a cross-sectional view taken along plane 31-31 in FIG. 28;

FIG. 32 is an isometric view of the closure body with the lid open, but without the spout installed, and prior to installation of the closure on the container;

FIG. 33 is a cross-sectional view similar to FIG. 29, but in FIG. 33 the container and spout have been omitted as in FIG. 32;

FIG. 34 is an isometric view of the spout as viewed from the rear end;

FIG. 35 is a cross-sectional view taken generally along the plane 35-35 in FIG. 34;

FIG. 36 is a bottom view of the spout taken along the plane 36-36 in FIG. 35; and

FIG. 37 is a cross-sectional view similar to FIG. 7, but FIG. 37 shows a third embodiment of the closure system of the present invention.

### DESCRIPTION OF THE PREFERRED EMBODIMENTS

While this invention is susceptible of embodiment in many different forms, this specification and the accompanying drawings disclose only some specific forms as examples of the invention. The invention is not intended to be limited to the embodiments so described, however. The scope of the invention is pointed out in the appended claims.

For ease of description, many of the figures illustrating the invention show the embodiments of the dispensing closure system as including a separate, removable, dispensing closure in the typical orientations that the closure would have at the top of a container when the container is stored upright on its base, and terms such as upper, lower, horizontal, etc., are used with reference to this position. It will be understood, however, that the closure system of this invention may be manufactured, stored, transported, used, and sold in an orientation other than the orientations described.

The dispensing closure system of this invention is suitable for use with a variety of conventional or special fluent substance dispensing systems, including packages, articles, and other dispensing equipment or apparatus, the details of which, although not fully illustrated or described, would be apparent to those having skill in the art and an understanding of such fluent substance dispensing systems. Such a fluent substance dispensing system, or portion thereof, with which the inventive dispensing closure system cooperates is hereinafter simply referred to as a “container.” The particular container, per se, that is illustrated and described herein forms no part of, and therefore is not intended to limit, the present invention. It will also be understood by those of ordinary skill that novel and non-obvious inventive aspects are embodied in the described exemplary dispensing closure system alone.

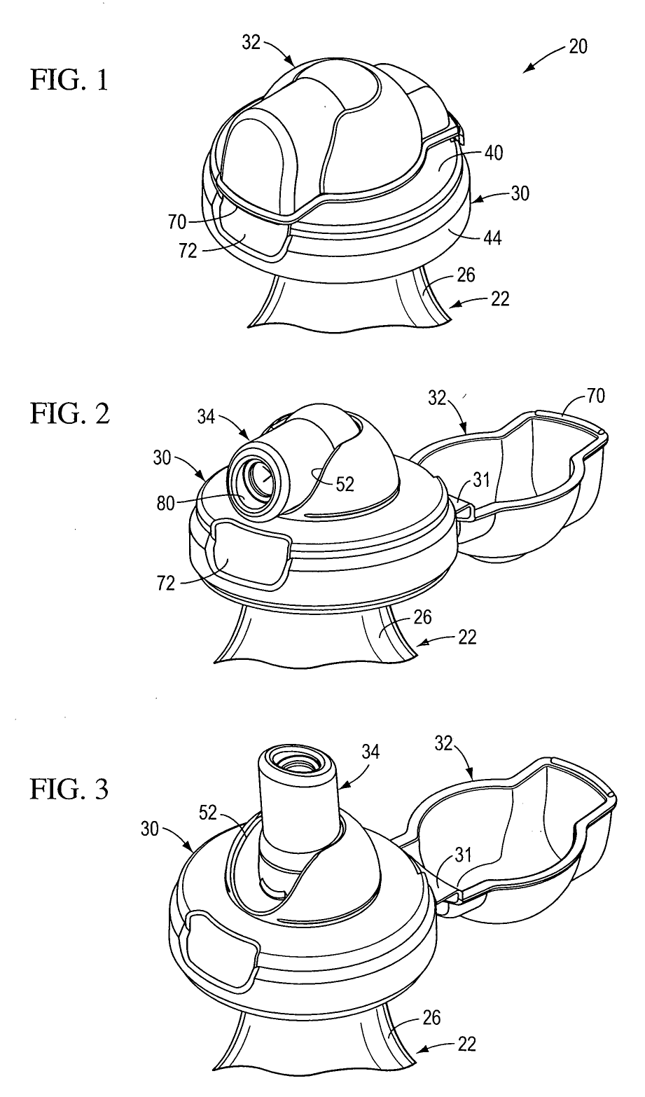

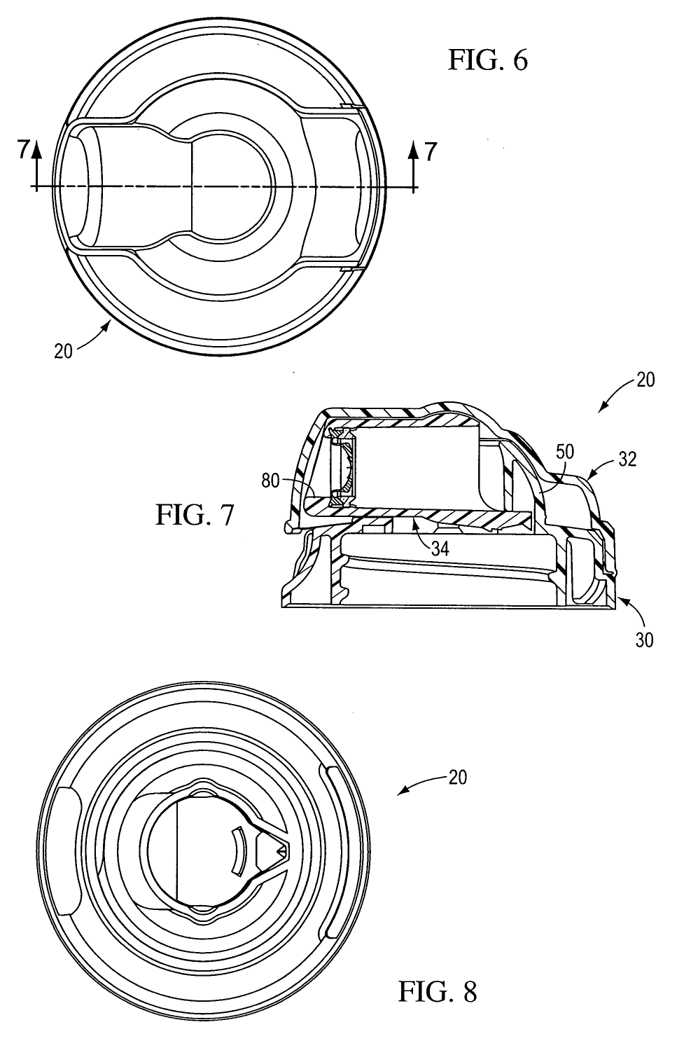

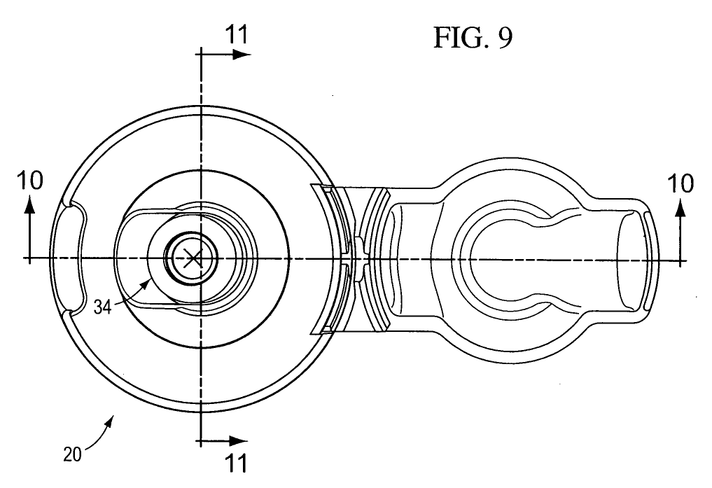

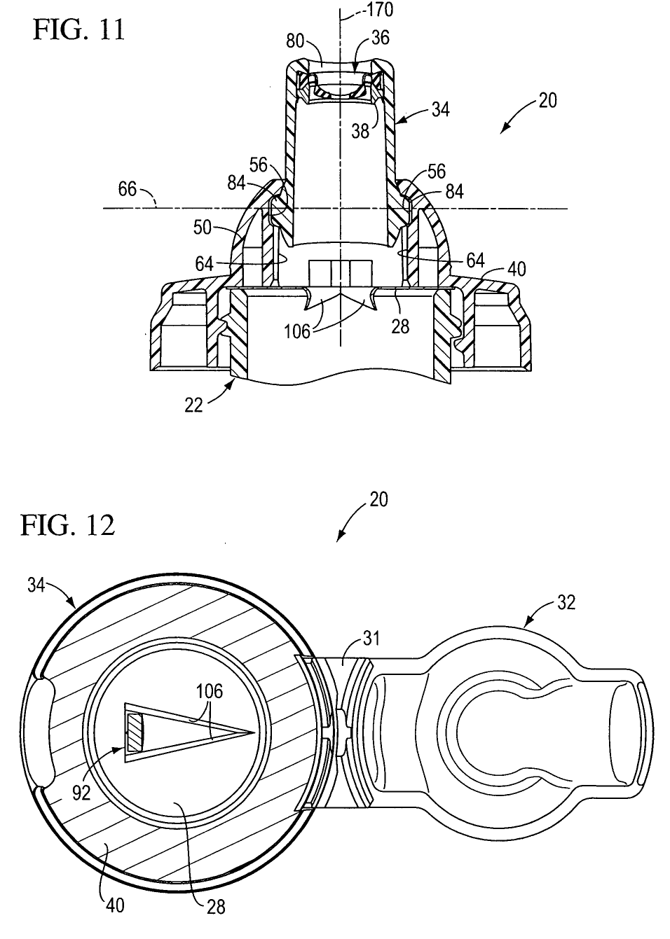

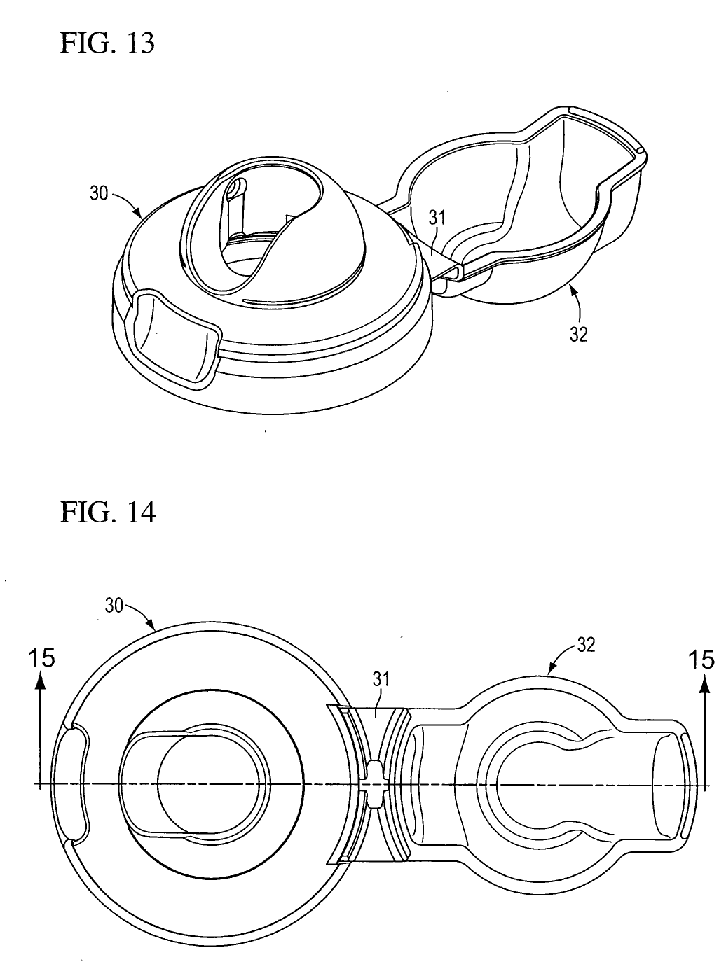

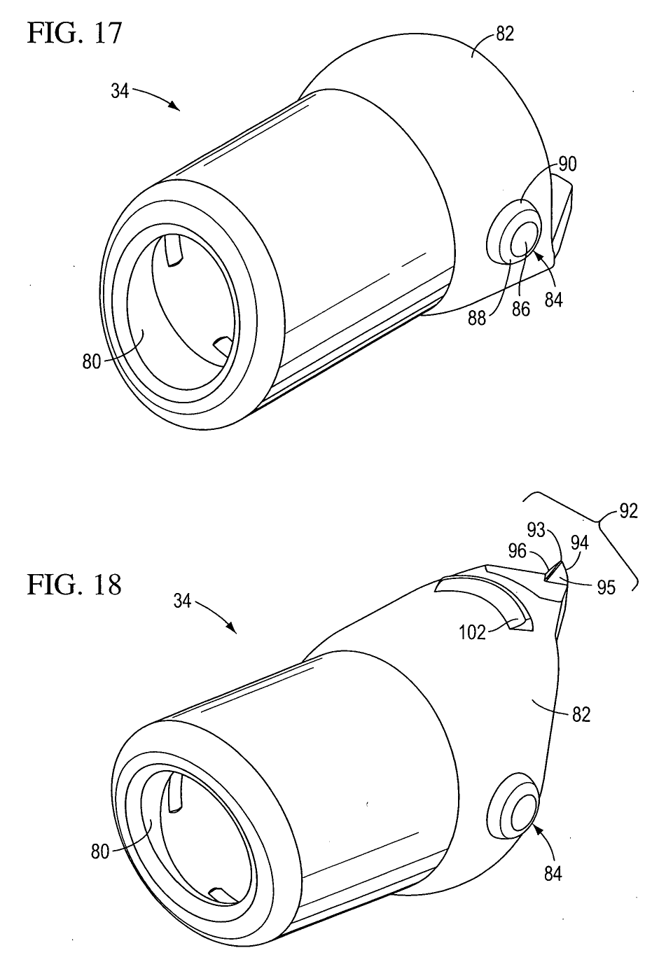

A first embodiment of a dispensing closure system of the present invention is illustrated in FIGS. 1-24 and is designated generally therein by reference number 20 in FIG. 1. In the first embodiment illustrated, the closure system 20 is provided in the form of a separate dispensing closure 20 which is adapted to be mounted or installed on a container 22 (FIGS. 1-5) that would typically contain a fluent substance.

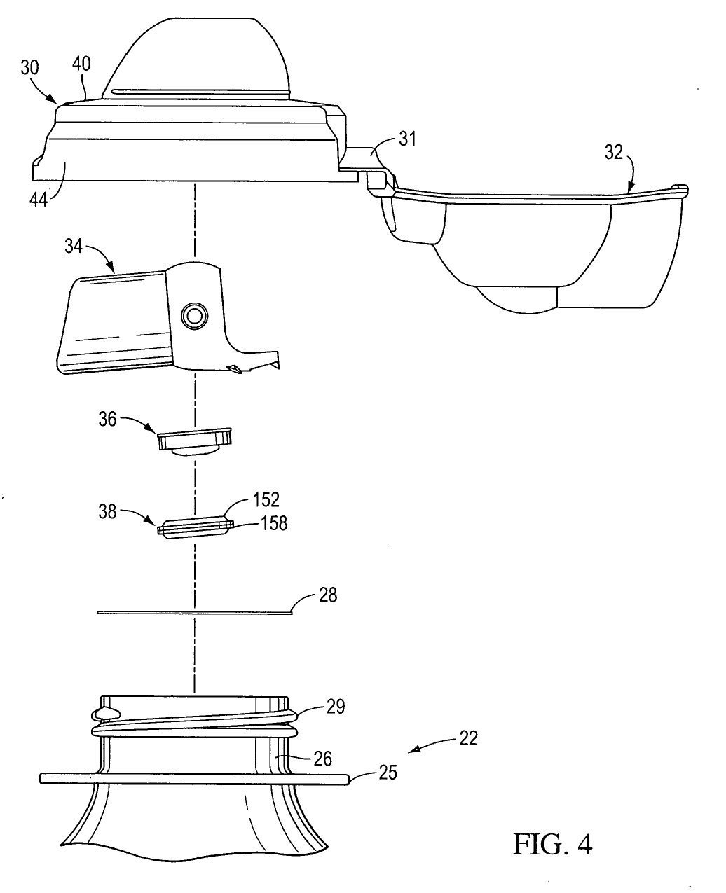

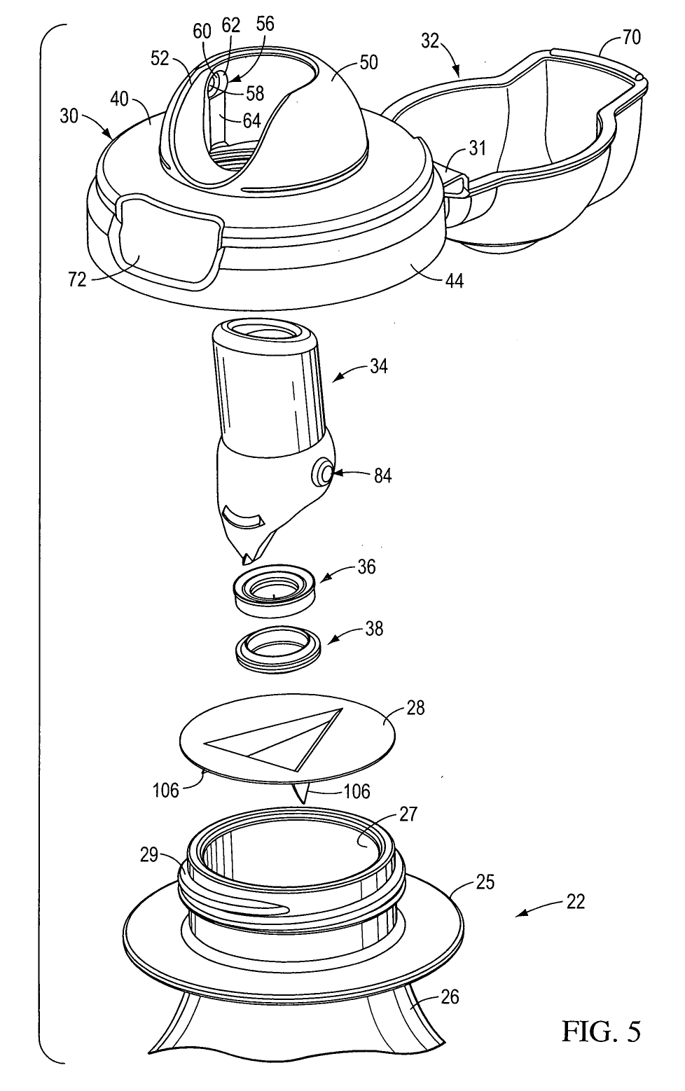

The container 22 includes a flange 25 and a neck 26 extending upwardly from a hollow body (not visible in the figures). The neck 26 defines an opening 27 (FIG. 5) to the container interior. A tamper-evident liner 28, defined by a membrane in the form of a pierceable disk, is initially disposed across the top of the container neck 26 over the opening 27 within the closure 20. FIG. 4 shows the liner 28 before piercing, and FIG. 5 shows the liner 28 after piercing. The liner 28 may be of any special or conventional type (e.g., aluminum foil (with or without a top and/or bottom laminated layer of thermoplastic material), or a completely non-metallic membrane that includes at least one layer of a thermoplastic material).

In one preferred embodiment form of a package employing the closure of the present invention, the liner 28 is typically heat sealed across, and to, the top of the container neck 26. The liner 28 could alternatively be sealed across, and to, a downwardly facing, interior surface or surfaces of the closure 20, instead of, or in addition to, being sealed across, and to, the top of the container neck 26.

The container neck 26, in the preferred embodiment illustrated in FIG. 5, has an external, male thread 29 for engaging the dispensing closure system 20. The body of the container 22 may have any suitable configuration, and the upwardly projecting neck 26 may have a different cross-sectional size and/or shape than the container body. (Alternatively, the container 22 need not have a neck 26, per se. Instead, the container 22 may consist of only a body with an opening.) The container 22 typically would have a somewhat flexible wall or walls.

Although the container 22, per se, does not form a part of the broadest aspects of the present invention, per se, it will be appreciated that at least a portion of the dispensing closure system 20 of the present invention optionally may be provided as a unitary portion, or extension, of the top of the container 22. However, in the preferred embodiment illustrated, the dispensing closure system 20 is a completely separate article or unit (e.g., a dispensing closure 20) which can comprise either one piece or multiple pieces, and which is adapted to be removably, or non-removably, installed either on a previously manufactured container 22 that has an opening 27 to the container interior or on some other fluent substance handling system. Hereinafter, the dispensing closure system or dispensing closure 20 will be more simply referred to as the closure 20.

The illustrated first embodiment of the closure 20 is adapted to be used with a container 22 having an opening 27 to provide access to the container interior and to a product (i.e., a material in the form of a fluent substance) contained therein (after the liner 28 is pierced). The closure 20 can be used to dispense substances, including, but not limited to, liquids, suspensions, mixtures, etc. (such as, for example, a personal care product, an industrial or household cleaning product, or other compositions of matter (e.g., compositions for use in activities involving manufacturing, commercial or household maintenance, construction, agriculture, medical treatment, military operations, etc.)).

The container 22 with which the closure 20 may be used would typically be a squeezable container having a flexible wall or walls which can be grasped by the user and squeezed or compressed to increase the internal pressure within the container so as to force the product out of the container and through the opened closure. Such a flexible container wall typically has sufficient, inherent resiliency so that when the squeezing forces are removed, the container wall returns to its normal, unstressed shape. Such a squeezable container is preferred in many applications but may not be necessary or preferred in other applications. For example, in some applications it may be desirable to employ a generally rigid container, and to pressurize the container interior at selected times with a piston or other pressurizing system, or to reduce the exterior ambient pressure around the exterior of the closure so as to suck the material out through the open closure.

It is presently contemplated that many applications employing the closure 20 will conveniently be realized by molding at least some of the components of the closure 20 from suitable thermoplastic material or materials. In the illustrated first embodiment, some of the components of the closure could be molded from a suitable thermoplastic material, such as, but not limited to, polypropylene. The closure components may be separately molded—and may be molded from different materials. The materials may have the same or different colors and textures.

As can be seen in FIG. 5, the presently most preferred form of the closure 20 includes four basic components, (1) a unitary molded body or base 30 and lid 32 connected together with an attached hinge 31, (2) a spout 34, (3) a dispensing valve 36 which is adapted to be mounted in the spout 34, and (4) a retaining ring 38 that retains the valve 36 in the upper part of the spout 34.

In the preferred form of the first embodiment of the invention, the lid 32 is provided to be closed over, and cover, the upper part of the closure body 30. The lid 32 can be moved to expose the upper part of the body 30 for dispensing. The lid 32 is movable between (1) a closed position over the body 30 (as shown in FIG. 1), and (2) an open position (as show in FIGS. 2 and 3). In an alternative design (not illustrated), the lid 32 may be a separate component which is completely removable from the closure body 30, or the lid 32 may be tethered to the body with a strap. In another alternative design (not illustrated), the lid could be omitted altogether. In the illustrated first embodiment, the lid 32 is hinged to the body 30 so as to accommodate pivoting movement of the lid 32 from the closed position to an open position.

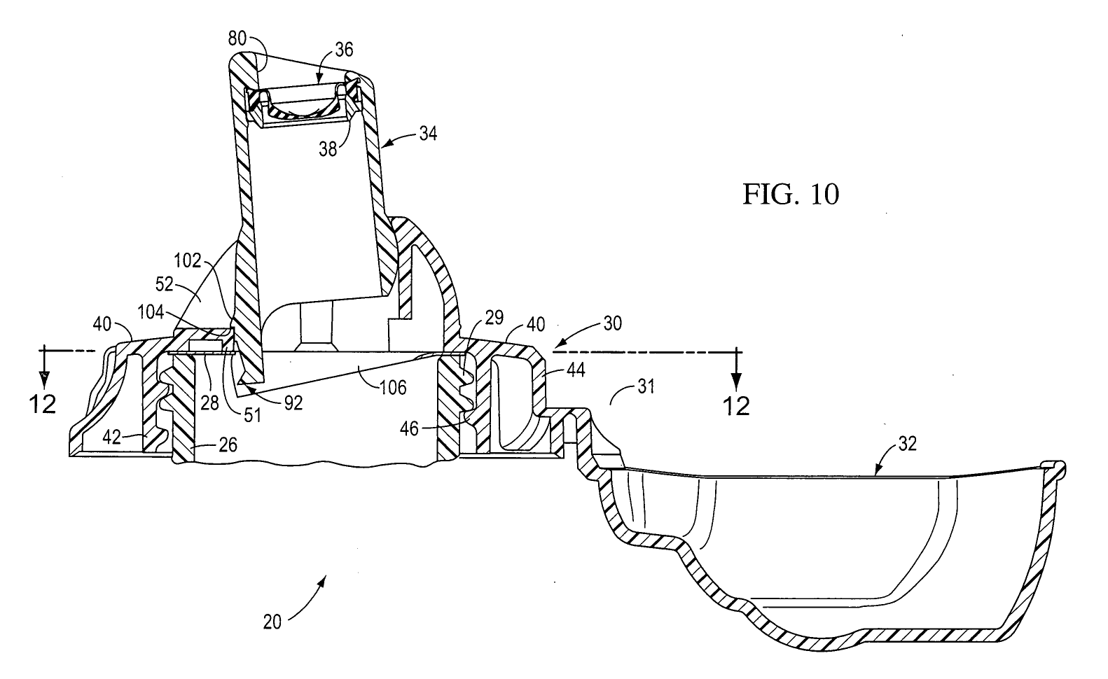

As can be seen in FIG. 5, the body 30 includes a deck 40. A skirt 44 extends downwardly from the periphery of the deck 40 as shown in FIGS. 5 and 10. As can be seen in FIGS. 5 and 10, an internal base or collar 42 extends downwardly from the deck 40 for engaging the container neck 26 when the closure body 30 is mounted on the container 22 as shown in FIG. 10.

As can be seen in FIG. 10. the interior of the internal base 42 defines an internal, female thread 46 for threadingly engaging the container neck external, male thread 29 (FIG. 10) when the dispensing closure body 30 is installed on the container neck 26.

Alternatively, the closure body internal base or collar 42 could be provided with some other container connecting means, such as a snap-fit bead or groove (not illustrated) for engaging a container neck groove or bead (not illustrated), respectively. Also, the closure body internal collar 42 could instead be permanently attached to the container 22 by means of induction melting, ultrasonic melting, gluing, or the like, depending on materials used for the closure body internal collar 42 and container 22. In another alternate design (not illustrated), the closure body internal collar 42 could be formed as a unitary part, or extension, of the container 22.

Although not illustrated, an annular seal member could optionally be provided to extend downwardly from the underside of the closure body deck 40. Such a seal member could be a conventional “V” seal, a conventional “plug” profile seal, a conventional “crab's claw” seal, or some other such conventional or special seal, depending upon the particular application.

The closure body collar 42 may have any suitable configuration for accommodating an upwardly projecting neck 26 of the container 22 or for accommodating any other portion of a container received within the particular configuration of the closure body internal collar 42—even if a container does not have a neck, per se. The main part of the container 22 may have a different cross-sectional shape than the container neck 26 and closure body internal collar 42. The closure body internal collar 42 may be adapted for mounting to other types of fluent substance handling container systems (e.g., including dispensing apparatus, machines, or equipment).

In the illustrated embodiment of the invention, the container neck receiving passage in the closure body internal collar 42 has a generally cylindrical configuration, but includes the inwardly projecting thread 46. However, the closure body collar 42 may have other configurations. For example, the closure body internal collar 42 might have a prism or polygon configuration adapted to be mounted to the top of a container neck having a polygon configuration. Such prism or polygon configurations would not accommodate the use of a threaded attachment, but other means of attachment could be provided, such as a snap-fit bead and groove arrangement, adhesive, or the like.

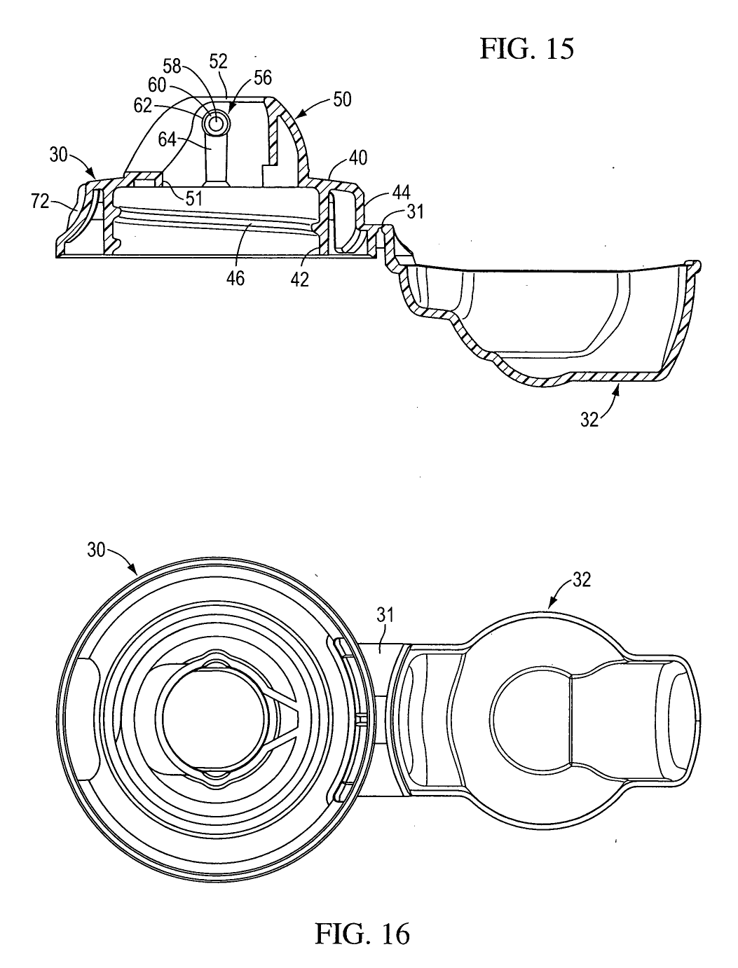

As can be seen in FIGS. 5 and 15, an enclosure 50 projects outwardly from the closure body deck 40. The enclosure 50 has a generally hemispherical, dome-like configuration in the illustrated first embodiment, and it extends outwardly (e.g., upwardly) from the deck 40. The enclosure 50 includes an interior volume or space for receiving the spout 34 (FIGS. 2 and 3). As can be seen FIG. 15, the enclosure 50 defines an opening 52 which accommodates the outward projection of the distal end portion of the spout 34. The opening 52 accommodates movement of the spout 34 from a retracted, non-dispensing position (FIGS. 2 and 7) which is generally parallel to, and above, the membrane 28 (FIG. 4) to a dispensing position in which the spout 34 projects outwardly from the body enclosure 50 (FIGS. 3 and 10). The enclosure 50 also preferably includes a wall or lip 51 (FIG. 15) adjacent the bottom of the opening 52 to help hold the spout 34 in the dispensing position as described hereinafter.

As can be seen in FIG. 11, interior wall portions o the enclosure 50 define a pair of spaced-apart, facing recesses 56 which function as sockets with bearing surfaces to receive a portion of the spout 34 as described in detail hereinafter. One of the recesses 56 inside the enclosure 50 is also visible in FIGS. 5 and 15. Each recess 56 includes a generally flat circular surface 58, an annular arcuate 60, and a less curved, almost frustoconical, surface 62 which extends around most of the annular arcuate surface 60. However, as can be seen in FIGS. 5 and 15, the surface 62 does not extend all the way around the bottom portion of the surface 60. Rather, towards the bottom of surface 60, the surface 62 terminates at, or is interrupted by, a vertical channel 64 (FIGS. 5 and 15). The channel 64 accommodates insertion of the spout into the enclosure 50 as will be described in detail hereinafter.

In the illustrated first embodiment, where a lid 32 is provided and where the lid 32 is connected to the closure body 30 with a hinge 31, the hinge 31 may be of any suitable type. One form of a hinge 31 that may advantageously be used is the snap-action type generally described in U.S. Pat. No. 4,403,712. Other types of hinges could be used. In some applications, the hinge could be omitted altogether, and the lid 32 need not be connected to the body 30 at all. In other applications, it may be desirable to omit the lid 32 entirely.

Where a lid, such as the lid 32, is employed, it may be desirable to provide a conventional latch bead along a portion or portions of the lower edge of the lid 32, and to provide a cooperating conventional latch bead or groove around a portion or portions of the edge of the closure body deck 40. When the lid 32 is closed, the lid latch bead overrides the body latch bead to form a latched engagement. To facilitate opening of the lid 32, the lid 32 includes a finger or thumb lift 70, and the closure body 30 defines a finger-receiving or thumb-receiving recess 72 (as can be seen in FIGS. 1, 2, and 5).

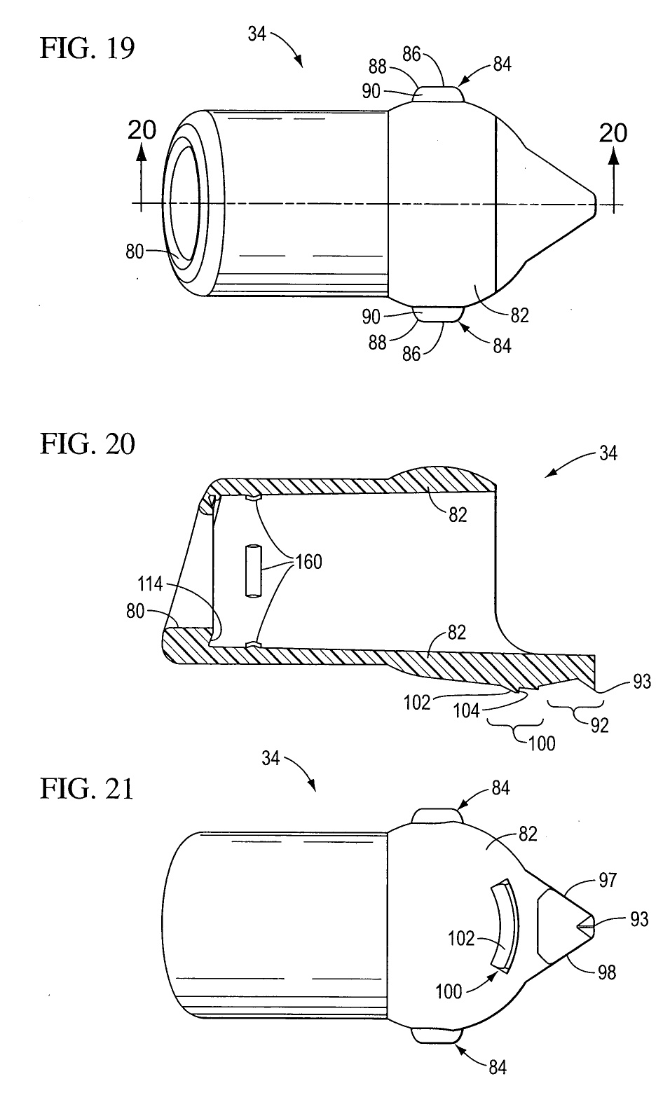

With reference to FIG. 17, the spout 34 includes a distal end having a dispensing opening 80, and includes an opposite end defining a base portion 82. As can be seen in FIG. 19, the base portion 82 includes a pair of oppositely extending pivot members 84. In the presently preferred embodiment, each member 84 has (1) a flat, circular surface 86, (2) a surrounding, annular curved surface 88, and (3) a less curved annular surface 90 surrounding the surface 88. Each pivot member 84 may be characterized as a “ball” for being received in one of the sockets or recesses 56 of the closure body enclosure 50 as can be seen in FIG. 11. The spout pivot member surfaces 86, 88, and 90 are configured or shaped to generally match, and mate with, the closure body recess surfaces 58, 60, and 62, respectively (FIG. 5).

The spout 34 can be initially installed into the closure body 30 by moving the spout 34 into the closure body 30 from below when the spout 34 is in the vertical orientation as illustrated in FIG. 5. During the installation process, the pivot members 84 are received in, and moved upwardly along, the closure body channels 64 (FIGS. 11 and 15). The as-fabricated (e.g., as-molded) lateral width of the spout base 82—from the circular disk surface 86 of one pivot member 84 to the circular disk surface 86 of the other pivot member 84—is slightly larger than the space defined in the closure body enclosure 50 between the bottoms of the two vertical channels 64. However, there is sufficient flexibility in the spout base 82 and/or in the portions of the enclosure 50 defining the channels 64 so as to accommodate temporary, elastic deformation of the spout base 82 and/or enclosure 50 by an amount sufficient to permit the spout pivot members 84 to enter into, and slide along, the vertical channels 64. When the pivot members 84 are received in the recesses 56 at the top of the channels 64, the inherent resiliency of the material of the spout 34 and/or of the enclosure 50 permit the pivot members 84 to be received in a snap-fit engagement in the recesses 56 to accommodate pivoting movement of the spout 34 between the substantially vertical dispensing position (FIGS. 3 and 11) and the retracted, non-dispensing position (FIGS. 2 and 7).

With reference to FIGS. 7 and 10, it will be appreciated that when the spout 34 is in the dispensing position, the spout 34 projects outwardly from the body 30 to locate the dispensing opening 80 at a dispensing location that is further outwardly than the non-dispensing location of the dispensing opening 80. The outward dispensing location of the opening 80 facilitates the dispensing of the fluent substance and facilitates the user's observation of the discharging fluent substance.

As can be seen in FIG. 18, the spout base 82 includes a piercing element, piercing edge, or piercing member 92. In the preferred embodiment, the piercing edge 92 includes a piercing point 93 defined by three converging surfaces 94, 95, and 96. As can be seen in FIG. 20, the piercing member or edge 92 extends beyond the rest of the spout 34 in the direction away from the dispensing opening 80. Further, the piercing edge or member 92 includes two, lateral, converging cutting or tearing edges 97 and 98 (FIG. 21).

The spout base 82 also defines a retention member 100 (FIG. 21) for holding the spout 34 in the dispensing orientation (FIG. 10). To this end, the retention member 100 includes an outwardly slanting surface 102 which terminates at a shoulder or ledge 104 (FIG. 20). As can be seen in FIG. 10, when the spout 34 is pivoted to the dispensing position, the angled surface 102 is adapted to engage, and slide along, the closure body lip 51. There is sufficient flexibility or resilience in the components (e.g., in the spout 34 and/or closure body 30) to accommodate a temporary, elastic deformation of one or both of the components to permit the spout 34 to be pivoted sufficiently to locate the ledge or shoulder 104 above the closure body lip 51. This engagement is sufficient to hold the spout 34 in the dispensing position during use, but is not so strong so as to prevent the user from pivoting the spout 34 back down to the retracted, non-dispensing position (FIG. 2).

When the spout 34 is pivoted to the dispensing position (FIGS. 3 and 9-12), the pivoting of the spout 34 to the dispensing position causes the spout bottom piercing edge 92 (FIG. 10) to pierce (e.g., puncture, penetrate, tear, cut open, etc.) the membrane 28 and create two, downwardly extending membrane flaps 106 (FIGS. 10 and 11).

The opening in the membrane 28 formed by the piercing member 92 (which, in the preferred illustrated embodiment, includes the point 93, the converging surfaces 94, 95, and 96, and the edges 97 and 98) permits the contents of the container to flow into the closure 20 and out of the spout 34—typically when the user inverts the package (consisting of the container 22 and closure 20) for dispensing the fluent product with the assistance of gravity, typically while the user is also squeezing the container 22 (if the container is of the squeezable type).

Although the spout 34 need not contain any valve (such as the valve 36), in the preferred embodiment illustrated the spout 34 contains the valve 36 located near the distal end of the spout 34 adjacent the dispensing opening 80 as can be seen in FIG. 10. In order to properly retain the particular form of the valve 36 employed with this embodiment of the invention, the spout 34 includes an annular wall or shoulder (FIG. 20) that extends around the opening 80 to define an annular seat 114 (FIG. 20), preferably in the configuration of a frustoconical surface, for being engaged by a peripheral portion of the valve 36 as described hereinafter. This accommodates the seating of the valve 36 in the spout 34. The surface or seat 114 functions as an annular, inwardly angled clamping surface for engaging the peripheral part of the valve 36 as explained in detail hereinafter.

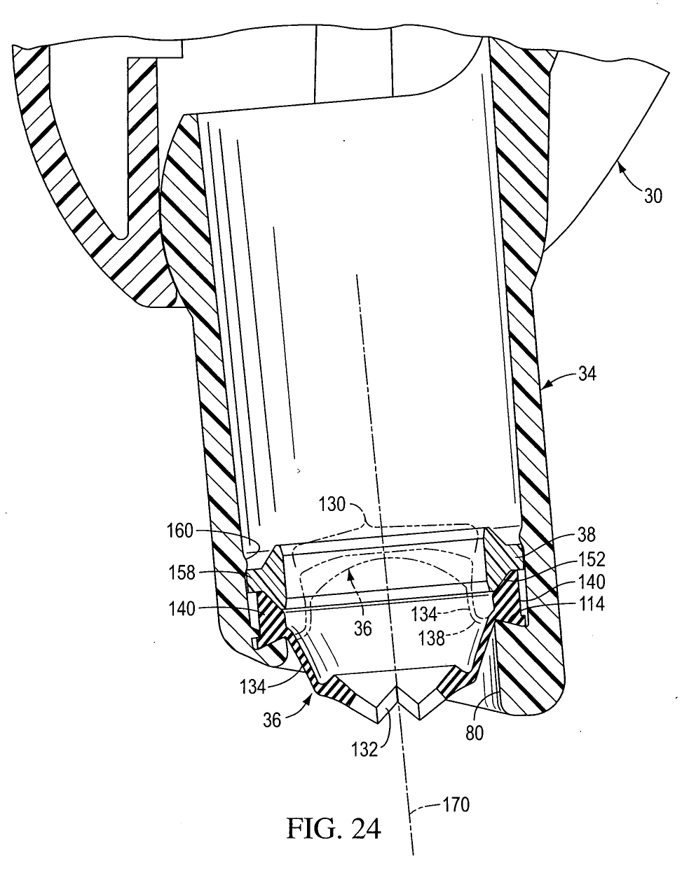

The valve 36 is adapted to be mounted in the closure spout 34 as shown in FIG. 24. The preferred form of the valve 36 is a pressure-actuatable, flexible, slit-type valve which is retained on the inside of the spout 34 by means of the retaining ring 38 as described in detail hereinafter.

The valve 36 is preferably molded as a unitary structure from material which is flexible, pliable, elastic, and resilient. This can include elastomers, such as a synthetic, thermosetting polymer, including silicone rubber, such as the silicone rubber sold by Dow Corning Corp. in the United States of America under the trade designation D.C. 99-595-HC. Another suitable silicone rubber material is sold in the United States of America under the designation Wacker 3003-40 by Wacker Silicone Company. Both of these materials have a hardness rating of 40 Shore A. The valve 36 could also be molded from other thermosetting materials or from other elastomeric materials, or from thermoplastic polymers or thermoplastic elastomers, including those based upon materials such as thermoplastic propylene, ethylene, urethane, and styrene, including their halogenated counterparts.

In the illustrated first embodiment, the valve 36 has the configuration and operating characteristics of a commercially available valve design substantially as disclosed in the U.S. Pat. No. 5,676,289 with reference to the valve 46 disclosed in the U.S. Pat. No. 5,676,289. The operation of such a type of valve is further described with reference to the similar valve that is designated by reference number 3d in the U.S. Pat. No. 5,409,144. The descriptions of those two patents are incorporated herein by reference thereto to the extent pertinent and to the extent not inconsistent herewith.

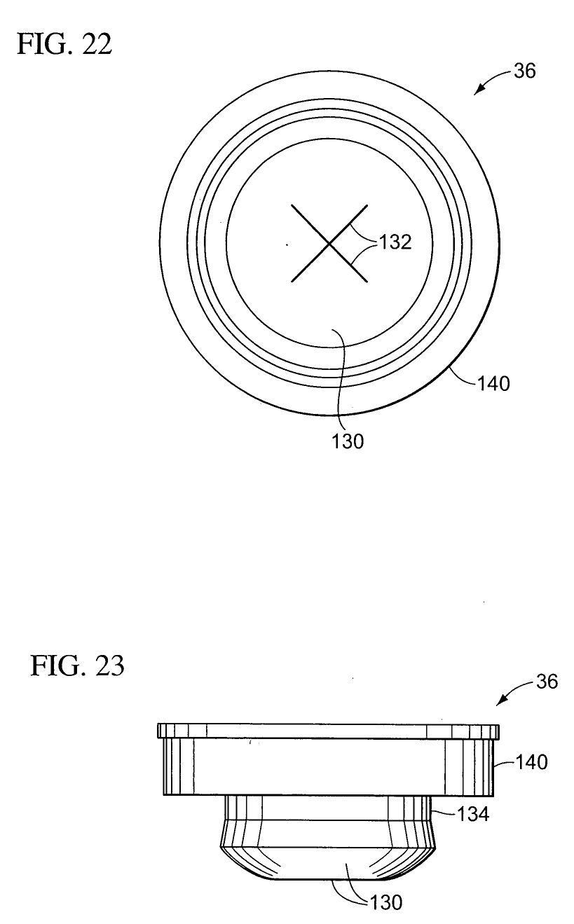

The valve 36 is flexible and changes configuration between (1) a closed, rest position (as shown closed in an upright package in FIGS. 10 and 11), and (2) an active, open position (as shown open in an inverted package in FIG. 24). The valve 36 includes a flexible, central portion or head 130 (FIGS. 22 and 23). When the valve 36 is not actuated, the head 130 has a concave configuration (when viewed from the exterior of the closure spout 34). The head 130 preferably has two, mutually perpendicular, planar, intersecting, dispensing slits 132 of equal length which together define a closed dispensing orifice. The intersecting slits 132 define four, generally sector-shaped, equally sized flaps or petals in the concave, central head 130. The flaps open outwardly from the intersection point of the slits 132 in response to an increasing pressure differential across the valve, when the pressure differential is of sufficient magnitude, in the well-known manner described in the U.S. Pat. No. 5,409,144. The valve 36 could be molded with the slits 132. Alternatively, the valve slits 132 could be subsequently cut into the central head 130 of the valve 36 by suitable conventional techniques.

As can be seen in FIG. 24, the valve 36 includes a skirt or sleeve 134 which extends from the valve central wall or head 130. At the outer end of the sleeve 134, there is a thin, annular flange 138 (FIG. 24) which extends peripherally from the sleeve 134 in a reverse angled orientation when the valve 36 is in the unactuated, rest condition. The thin flange 138 merges with an enlarged, much thicker, peripheral flange 140 which has a generally dovetail-shaped, transverse cross section (as viewed in FIG. 24).

To accommodate the seating of the valve 36 in the spout 34, the top surface of the dovetail valve flange 140 has the same frustoconical configuration and angle as the spout frustoconical surface 114.

The other surface (i.e., bottom surface) of the valve flange 140 is clamped by the retaining ring 38 (FIGS. 4, 10, and 24). The retaining ring 38 includes an outwardly or upwardly facing, frustoconical, annular clamping surface 152 (FIGS. 4 and 24) for engaging the inner surface (i.e., bottom surface) of the valve flange 140 at an angle which matches the angle of the adjacent, inner surface of the valve flange dovetail configuration.

The peripheral portion of the retaining ring 38 includes an outwardly projecting flange or bead 158 (FIGS. 4 and 24) for snap-fit engagement with a series of circumferentially spaced-apart, arcuate beads 160 (FIG. 24) that project radially inwardly on the inside of the spout 34. Before the spout 34 is installed in the closure body 30, the valve 36 can be inserted into the spout 34 along with the retaining ring 38. The valve flange 140 is temporarily deformed as the valve 36 is pushed past the beads 160 with the ring 38, and the valve flange 140 seats against the spout frustoconical seating surface 114. The retaining ring 38 can also be pushed past the retaining beads 160 because there is sufficient flexibility in the spout 34 to accommodate temporary, elastic deformation (expansion) of the spout 34 as the retaining ring bead 158 passes over and beyond the spout beads 160 to create a snap-fit engagement that compresses or clamps the valve flange 140 against the spout frustoconical surface 114 (FIG. 24). This permits the region adjacent the interior surface of the valve sleeve 134 to be substantially open, free, and clear so as to accommodate movement of the valve sleeve 134 as described hereinafter.

In contemplated alternate embodiments (not illustrated), the valve 36 could be suitably attached to a unitary mounting fitment in the spout 34 or otherwise retained in the spout 34 by various means, including swaging, coining, gluing, ultrasonic welding, etc. In another contemplated alternate embodiment (not illustrated), the closure spout 34 could be molded to form a generally rigid, unitary structure, an then the valve 36 could be bi-injection molded into the spout 34 (or, optionally, onto the exterior, distal end of the spout 34) without the need for a retaining ring 38.

When the valve 36 is mounted within the particular form of the spout 34 as illustrated in FIGS. 10 and 24, the central head 130 of the valve 36 lies recessed within the retaining ring 38. In the preferred embodiment, the exterior surface of the valve head portion 130 at the center of the slits 132 (FIG. 22) is below the clamping surface 114 of the spout 34 when the valve 36 is closed. However, when the package is inverted and/or squeezed to dispense the contents through the valve 36, then the valve head 130 is forced outwardly from its recessed position (shown in dashed lines in FIG. 24) toward the end of the package and beyond the retaining ring 38—closer to the open end of the spout 34.

In order to dispense product, the package is typically tipped downwardly, or is completely inverted (and also squeezed if the container is of the squeezable type). FIG. 24 shows orientation of a valve 36 when the package is inverted and the container 22 is squeezed. The container 22 is squeezed to increase the pressure within the container 22 above the ambient exterior atmospheric pressure. This forces the product in the container 22 toward and against the valve 36, and that forces the valve 36 from the recessed or retracted position (shown in dashed lines in FIG. 24) toward an outwardly extending position (shown in solid lines in FIG. 24). The outward displacement of the central head 130 of the valve 36 is accommodated by movement of the relatively thin, flexible sleeve 134. The sleeve 134 moves from an inwardly projecting, rest position (shown in dashed lines in FIG. 24) to an outwardly displaced, pressurized position, and this occurs by the sleeve 134 “rolling” along itself outwardly toward the outer end of the package (toward the position shown in solid lines in FIG. 24).

However, when the internal pressure becomes sufficiently high after the valve central head 130 has moved outwardly to the fully extended position, the slits 132 of the valve 36 open to dispense the fluent material (not shown in FIG. 24). The fluent material is then expelled or discharged through the open slits 132.

The above-discussed dispensing action of valve 36 in a squeeze type package with a lid 32 typically would occur only after (1) the lid 32 has been moved to the open position (FIG. 2), (2) the package has been tipped or inverted, and (3) the container 22 is squeezed. Pressure on the interior side of the valve 36 will cause the valve to open when the differential between the interior and exterior pressure reaches a predetermined amount. Preferably, the valve 36 is designed to open only after a sufficiently great pressure differential acts across the valve 36—as by a sufficiently reduced pressure (i.e., vacuum) being applied to the spout 34 and/or by squeezing the container 22 with sufficient force (if the container 22 is not a rigid container).

Depending on the particular valve design, the open valve 36 may close when the pressure differential decreases, or the valve may stay open even if the pressure differential decreases to zero. In the preferred embodiment of the valve 36 illustrated for the preferred embodiment of the system shown in FIGS. 1-24, the valve 36 is designed to close when the pressure differential decreases to, or below, a predetermined magnitude. Thus, when the squeezing pressure on the container 22 is released, the valve 36 closes, and the valve head 130 retracts to its recessed, rest position within the spout 34.

Preferably, the valve 36 is designed to withstand the weight of the fluid on the inside of the valve 36 when the container 22 is completely inverted. With such a design, if the container 22 is inverted while the valve 36 is closed, but the container 22 is not being squeezed, then the mere weight of the fluent substance on the valve 36 does not cause the valve 36 to open, or to remain open. Further, if the container 22 on which the closed valve 36 is mounted inadvertently tips over after the lid 32 is opened and the spout 34 is in the dispensing position, then the product still does not flow out of the valve 36 because the valve 36 remains closed.

In one preferred embodiment, the petals of the valve 36 open outwardly only when the valve head 130 is subjected to a predetermined pressure differential acting in a gradient direction wherein the pressure on the valve head interior surface exceeds—by a predetermined amount—the local ambient pressure on the valve head exterior surface. The product can then be dispensed through the open valve 36 until the pressure differential drops below a predetermined magnitude, and the petals then close completely.

If the preferred form of the valve 36 has also been designed to be flexible enough to accommodate in-venting of ambient atmosphere as described in detail below, then the closing petals can continue moving inwardly to allow the valve 36 to open inwardly as the pressure differential gradient direction reverses and the pressure on the valve head exterior surface exceeds the pressure on the valve head interior surface by a predetermined magnitude.

For some dispensing applications, it may be desirable for the valve 36 not only to dispense the product, but also to accommodate such in-venting of the ambient atmosphere (e.g., so as to allow a squeezed container (on which the valve is mounted) to return to its original shape). Such an in-venting capability can be provided by selecting an appropriate material for the valve construction, and by selecting appropriate thicknesses, shapes, and dimensions for various portions of the valve head 130 for the particular valve material and overall valve size. The shape, flexibility, and resilience of the valve head, and in particular, of the petals, can be designed or established so that the petals will deflect inwardly when subjected to a sufficient pressure differential that acts across the head 130 and in a gradient direction that is the reverse or opposite from the pressure differential gradient direction during product dispensing. Such a reverse pressure differential can be established when a user releases a squeezed, resilient container 22 on which the valve 36 is mounted. The resiliency of the container wall (or walls) will cause the wall to return toward the normal, larger volume configuration. The volume increase of the container interior will cause a temporary, transient drop in the interior pressure. When the interior pressure drops sufficiently below the exterior ambient pressure, the pressure differential across the valve 36 will be large enough to deflect the valve petals inwardly to permit in-venting of the ambient atmosphere. In some cases, however, the desired rate or amount of in-venting may not occur until the squeezed container is returned to a substantially upright orientation that allows the product to flow under the influence of gravity away from the valve 36.

It is to be understood that the valve dispensing orifice may be defined by structures other than the illustrated slits 132. If the orifice is defined by slits, then the slits may assume many different shapes, sizes and/or configurations in accordance with those dispensing characteristics desired. For example, the orifice may also include five or more slits.

The dispensing valve 36 is preferably configured for use in conjunction with a particular container and with a specific type of product, so as to achieve the exact dispensing characteristics desired. For example, the viscosity and density of the fluid product can be factors in designing the specific configuration of the valve 36 for liquids, as is the shape, size, and strength of the container. The rigidity and durometer of the valve material, and size and shape of the valve head 130, are also valve characteristics relevant to the desired dispensing characteristics, and can be matched with both the container and the substance to be dispensed therefrom.

Preferably, the valve 36 and the interior of the spout 34 each has a generally circular configuration and are aligned along a common longitudinal axis 170 as illustrated in FIGS. 11 and 24. The central intersection of the valve slits 132 lies on the longitudinal axis 170. The spout 34 may be characterized as having an axially outward discharge flow direction along the axis 170.

The novel closure system may be provided and used with a different kind of valve (e.g., a mechanically actuated valve) or without any valve, if desired. In any case, the spout 34 in the closure system of the present invention can be easily and effectively operated to pierce (e.g., puncture, break, tear, cut, etc.) a membrane that is initially in place to maintain the integrity of the fluent substance that is to be discharged. The closure system does not require the complete removal of a separate element (such as the membrane 28) prior to discharging the contents—thereby eliminating the possibility of losing an important component of the dispensing system.

The closure system accommodates movement of the spout 34 to a retracted, non-dispensing position in which it is less likely to be subjected to inadvertent impact or engagement with objects in the surrounding environment. Pivoting of the spout 34 away from the non-dispensing position to the dispensing position for the first time by the user automatically results in the piercing of the protective membrane 28.

Embodiments of the present invention wherein the spout 34 and closure body 30 are separately manufactured components (such as the embodiment illustrated in FIGS. 1-24) can be relatively easily assembled by the manufacturer. The system of the present invention accommodates use with packages wherein the membrane 28 is sealed to, and across, the top of the container 22 as well as in other, optional designs wherein the membrane 28 can be secured to the underside of the closure body 30 instead of, or in addition to, the top of the container 22.

When the present invention employs the optional valve 36 (as in the preferred embodiment illustrated in FIGS. 1-24), the valve 36 provides additional advantages, such as preventing spillage of the fluent material if the opened package is inadvertently tipped over, and providing additional control of the dispensing process (including minimizing, if not eliminating, the dripping of fluent material from the spout 34 after the dispensing process has been terminated by the user). The valve 36 also can function to eliminate or minimize contaminant ingress even if no external lid is provided for closing over the top of the spout 34.

The dispensing closure system of the present invention accommodates the use of the a membrane 28, such as a conventional liner, without requiring removal of the liner from the container or system. The dispensing closure system of the present invention permits the user to conveniently open a membrane (such as a conventional liner) without having to manipulate the package so as to first expose the membrane and without requiring removal of the membrane per se. The membrane or liner, after piercing, remains on the container in the system so that it does not present a litter problem or choking problem for children.

Further, the dispensing closure system spout 34 of the present invention may be used as a “straw” for withdrawing a beverage from the package.

Because the dispensing closure system is adapted for use with a membrane 28, such as a conventional liner that is sealed over the container, the system inhibits tampering with the package, and provides evidence of tampering if the membrane 28 has been pierced before the intended first user receives the package.

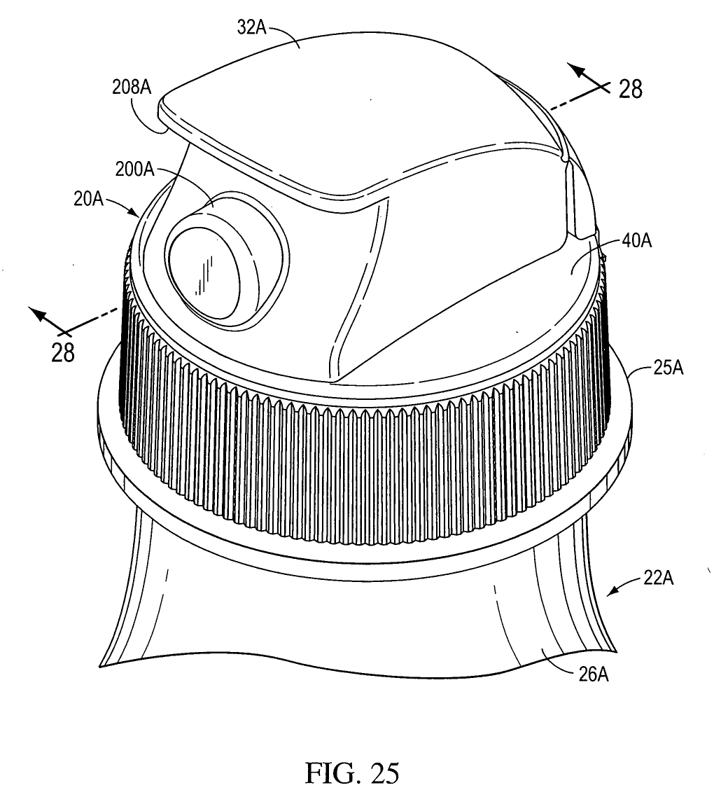

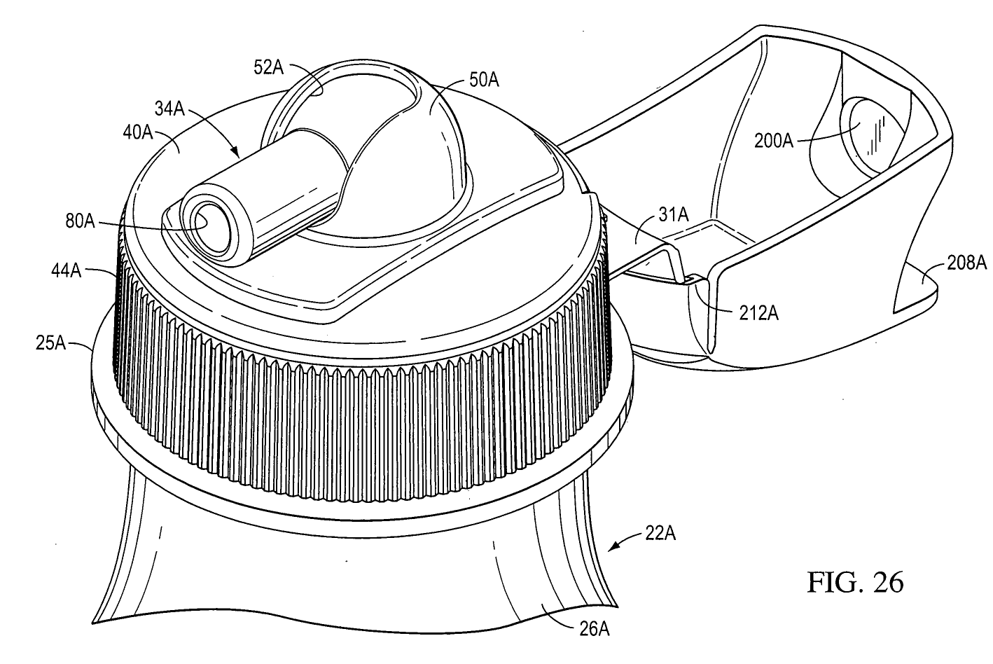

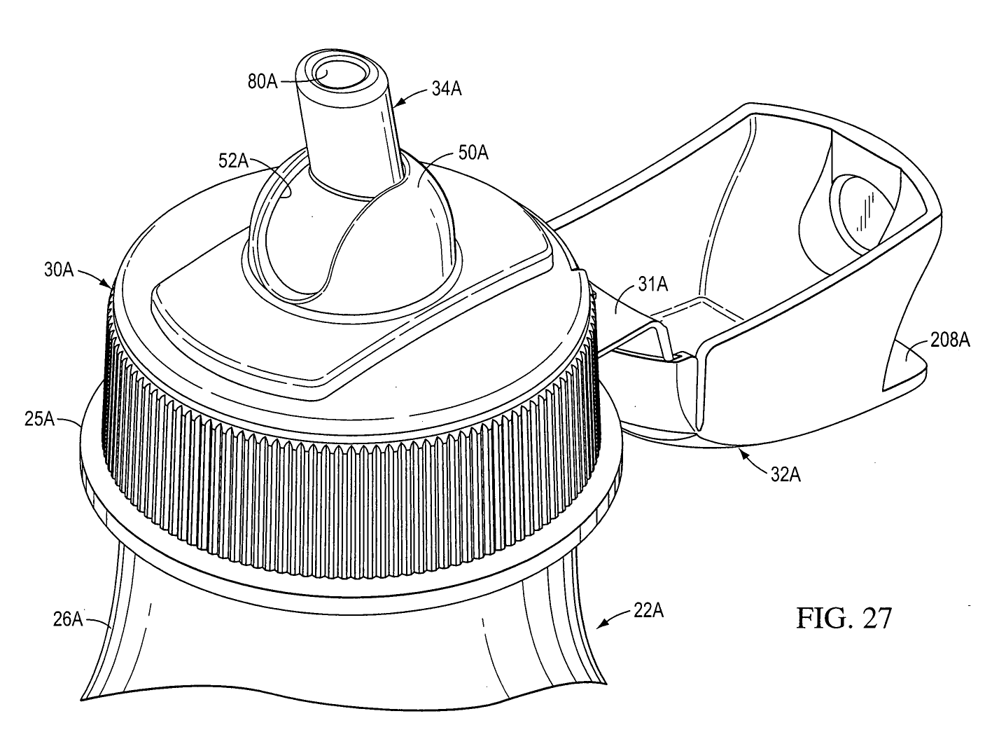

A second embodiment of a dispensing closure system of the present invention is illustrated in FIGS. 25-36 and is designated generally therein by reference number 20A in FIG. 25. In the second embodiment illustrated, the closure system 20A is provided in the form of a separate dispensing closure 20A which is adapted to be mounted or installed on a container 22A (FIGS. 1-5) that would typically contain a fluent substance. Many of the features of the second embodiment are identical or similar in structure and function with the corresponding features of the first embodiment described above with reference to FIGS. 1-24 and are not here described in detail.

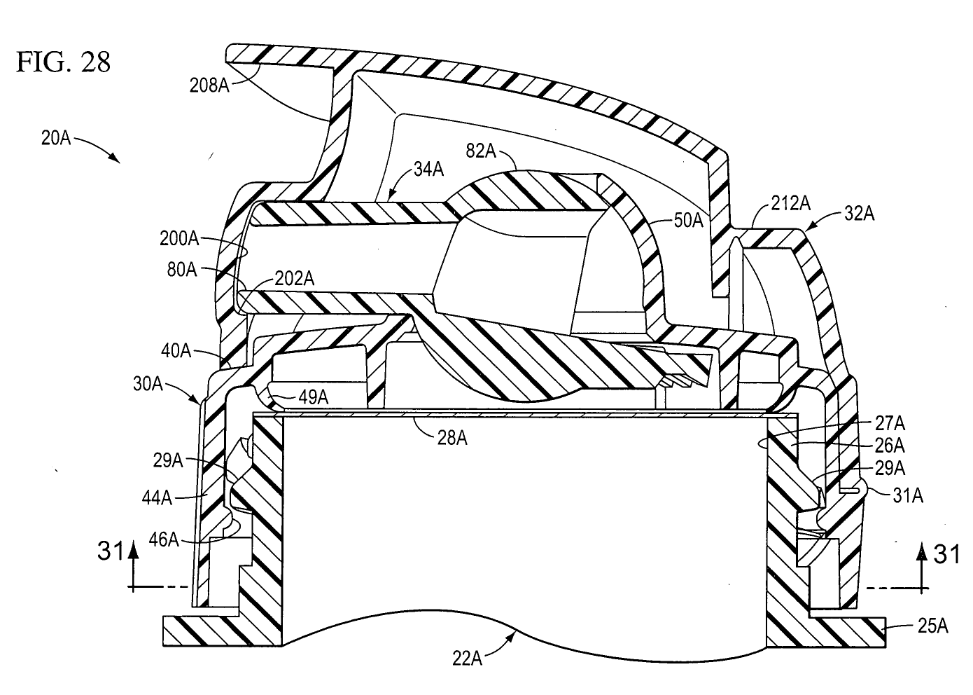

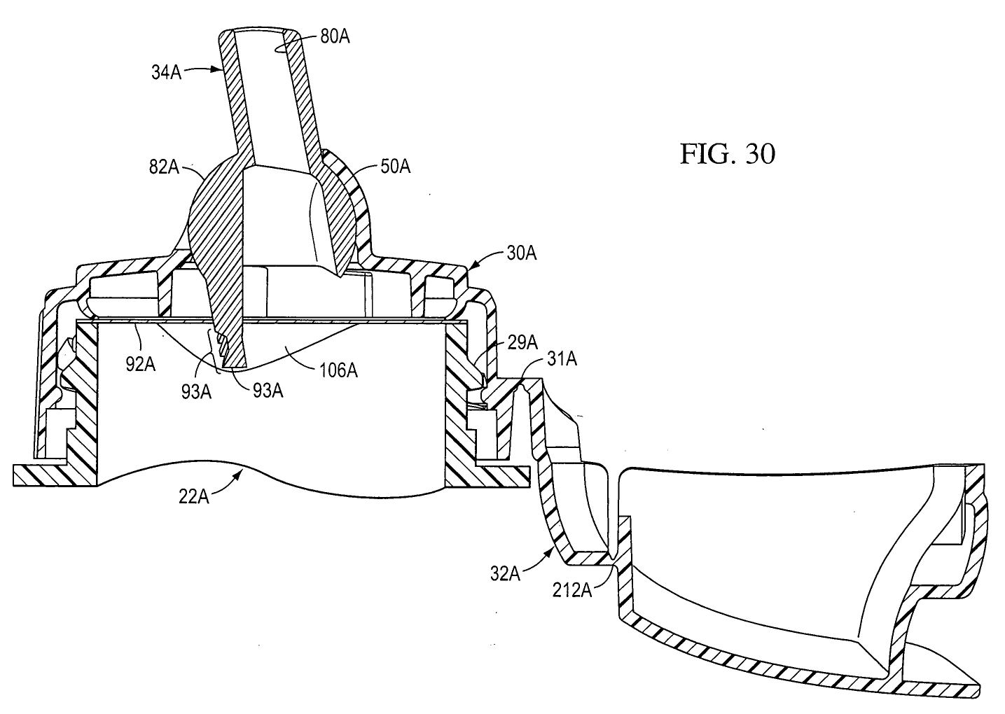

The container 22A includes a flange 25A and a neck 26A extending upwardly from a hollow body (not visible in the figures). The neck 26A defines an opening 27A (FIG. 28) to the container interior. A tamper-evident liner 28A, defined by a membrane in the form of a pierceable disk, is initially disposed across the top of the container neck 26A over the opening 27A within the closure 20A. FIG. 28 shows the liner 28A before piercing, and FIG. 30 shows the liner 28A after piercing. The liner 28A may be the same as the liner 28 used in the first embodiment described above with reference to FIGS. 1-24.

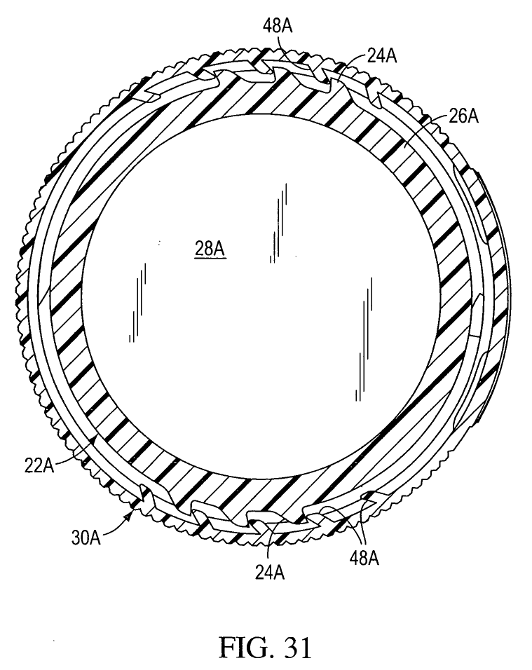

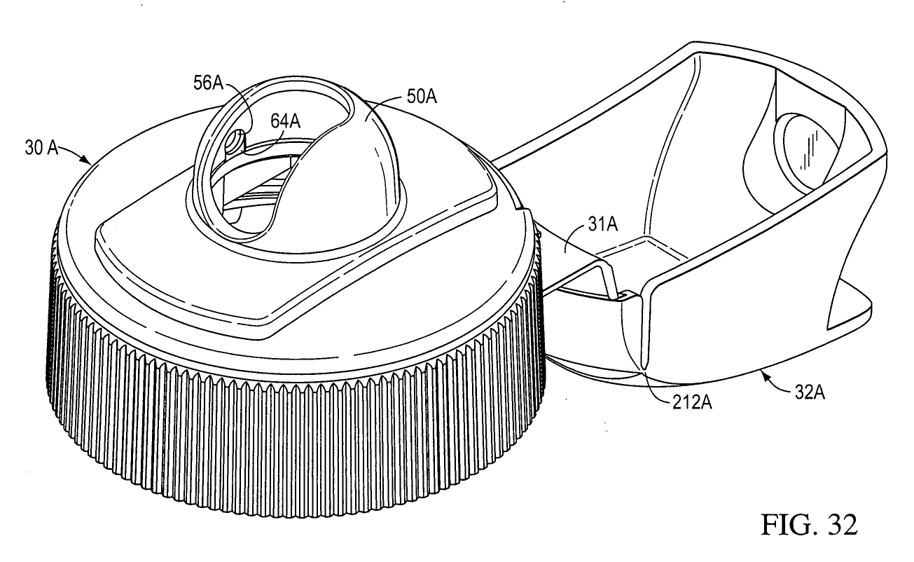

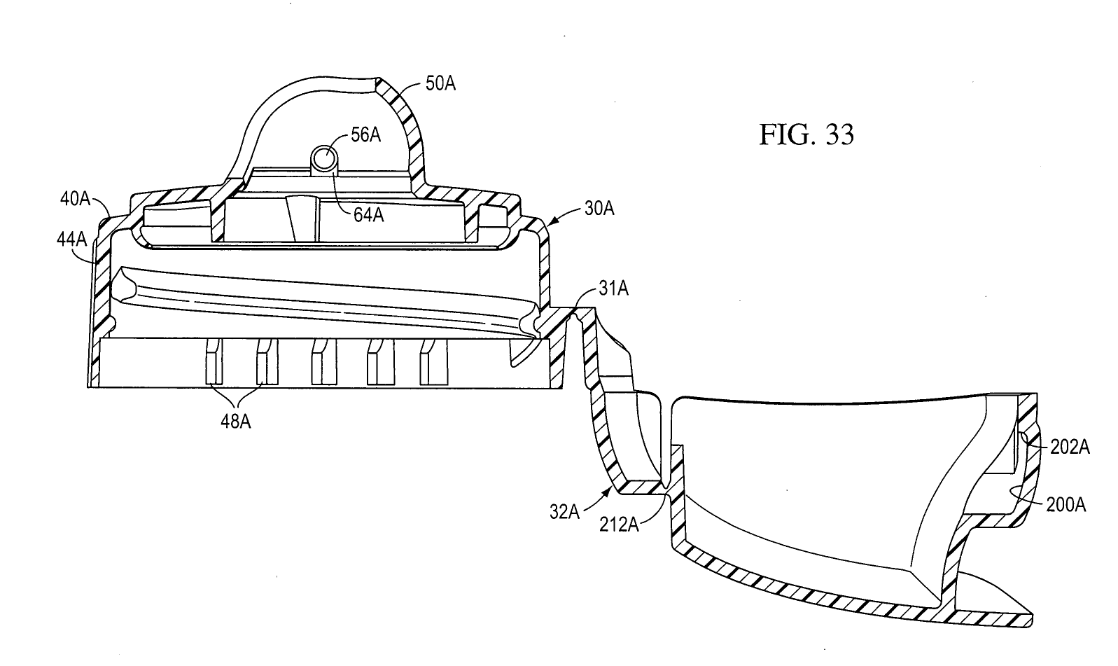

The container neck 26A, in the preferred embodiment illustrated in FIG. 28, is similar to the first embodiment container neck 26 described above with reference to FIGS. 1-5, 10, and 11. The container neck 26A has an external, male thread 29A (FIG. 28) for engaging the dispensing closure 20A. However, as can be seen in FIG. 31, the container neck 26A also has peripheral ratchet teeth 24A arranged below the thread 29A in two circumferentially spaced groups of teeth 24A, with three teeth 24A in each group. The teeth 24A can engage the closure 20A as described in detail hereinafter.

As can be seen in FIG. 30, the second embodiment of the closure 20A includes two basic components, (1) a unitary molded body or base 30A and lid 32A connected together with an attached hinge 31A, and (2) a spout 34A. The spout 34A does not a have valve and retaining ring such as the first embodiment dispensing valve 36 and retaining ring 38.

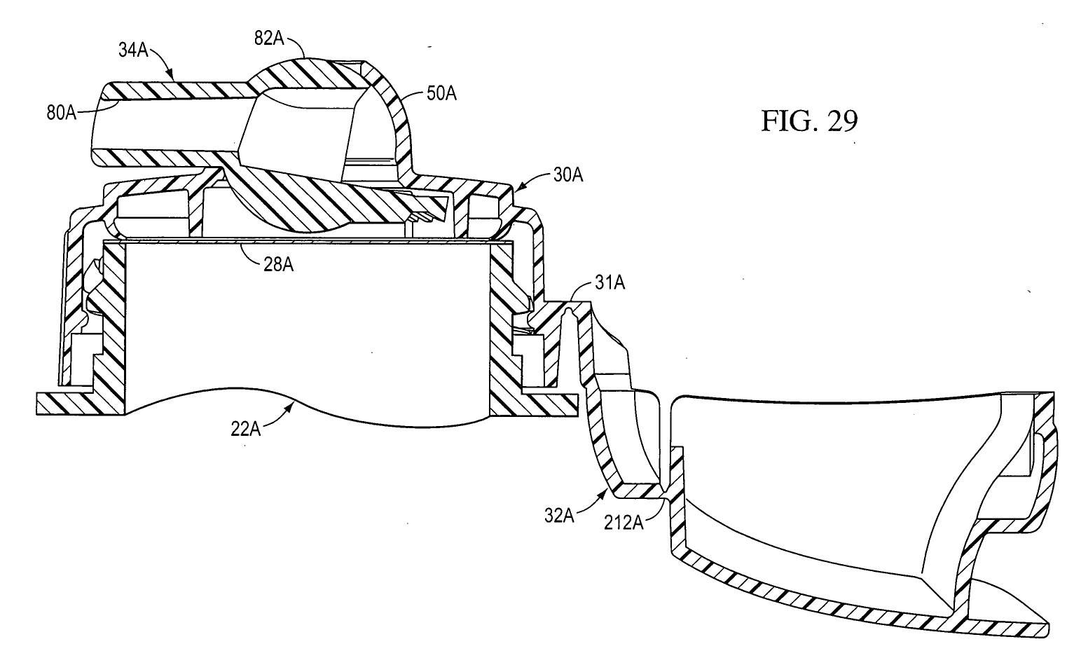

As with the first embodiment of the invention, the second embodiment lid 32A is provided to be closed over, and cover, the upper part of the closure body 30A. The lid 32A can be moved to expose the upper part of the body 30A for dispensing. The lid 32A is movable between (1) a closed position over the body 30A (as shown in FIGS. 1 and 28), and (2) an open position (as show in FIGS. 26 and 29). In an alternative design (no t illustrated), the lid 32A may be a separate component which is completely removable from the closure body 30A, or the lid 32A may be tethered to the body with a strap. In another alternative design (not illustrated), the lid could be omitted altogether. In the illustrated second embodiment, the lid 32A is hinged to the body 30A so as to accommodate pivoting movement of the lid 32A from the closed position to an open position.

As can be seen in FIGS. 26 and 29, the closure body 30A has an enclosure 50 which projects outwardly. The enclosure 50A has a generally hemispherical, dome-like configuration. The enclosure 50A includes an interior volume or space for receiving part of the spout 34A. As can be seen FIG. 26, the enclosure 50A defines an opening 52A which accommodates the outward projection of the distal end portion of the spout 34A. The opening 52A accommodates movement of the spout 34A between (1) a retracted, non-dispensing position (FIGS. 26 and 29) which is generally parallel to, and above, the membrane 28A (FIG. 29), and (2) a dispensing position in which the spout 34A projects outwardly from the body enclosure 50A (FIGS. 27 and 30).

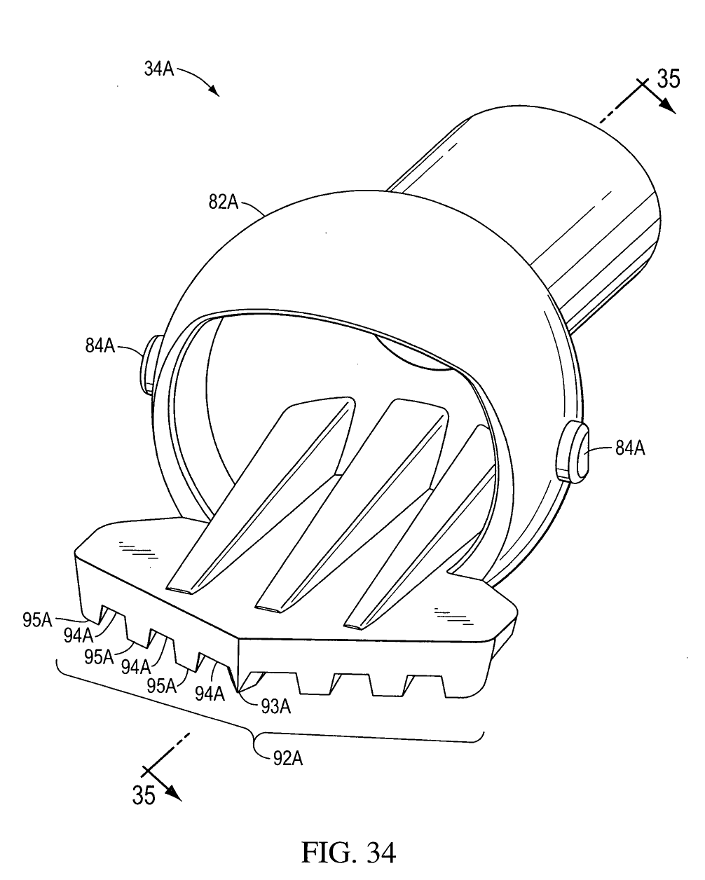

Compared to the first embodiment, the second embodiment body 30A, lid 32A, and spout 34A have modified configurations. The modified configurations provide an enhanced enclosure of the spout 34A. In particular, with reference to FIGS. 28 and 32, the closure body upwardly projecting enclosure 50A fits more closely around more of the rear end of the spout 34A (FIG. 28) than does the analogous enclosure 50 for the first embodiment illustrated in FIG. 7. When the second embodiment spout 34A is in the substantially horizontal, non-dispensing position shown in FIG. 28, the closure base enclosure 50A extends sufficiently far upwardly and forwardly to completely cover the opening at the rear end of the spout 34A.

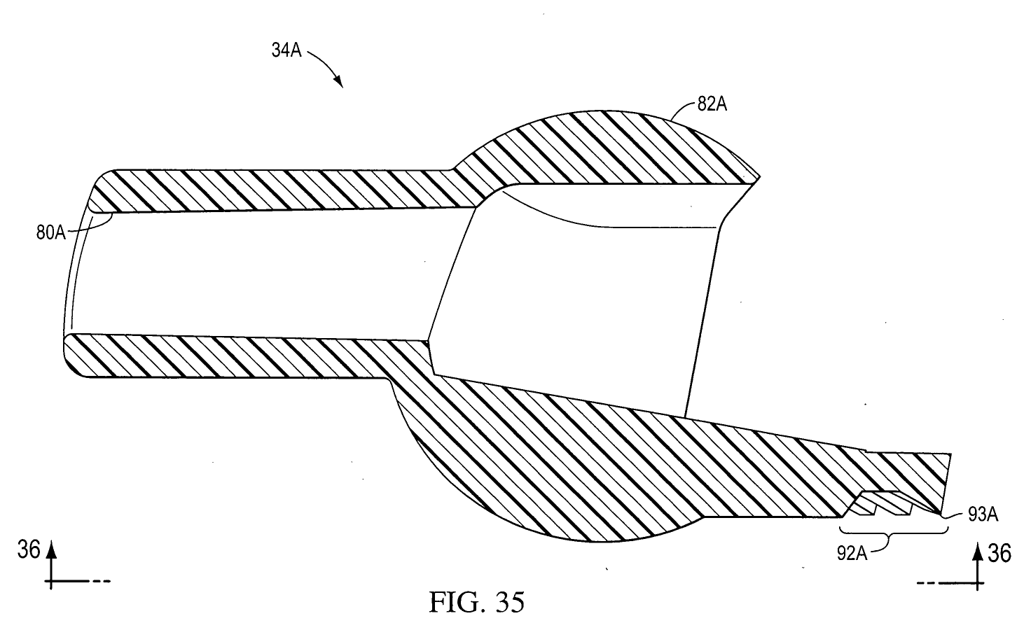

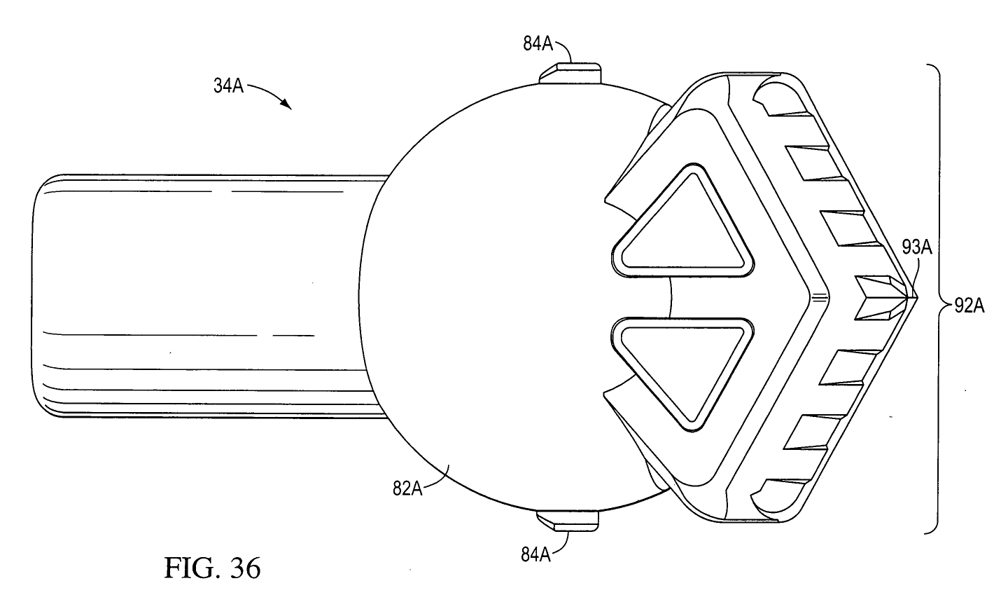

With reference to FIG. 35, the spout 34A includes a front, distal end having a dispensing opening 80A, and includes an opposite end defining a base portion 82A. The base portion 82A is more round, or ball-shaped, than the first embodiment base portion 82 (compare FIGS. 20 and 35). As can be seen in FIG. 36, the base portion 82A includes a pair of oppositely extending pivot members 84A. Each pivot member 84A may be characterized as a “ball” for being received in one of two sockets or recesses 56A on the inside of the closure body enclosure 50A (the recesses 56A can be seen in FIGS. 32 and 33).

The spout 34A can be initially installed into the closure body 30A (before the closure 20A is installed on the container 22A) by moving the spout 34A into the closure body 30A from below while the spout 34A is in the vertical orientation as illustrated in FIG. 30. During the installation process, the pivot members 84A are received in, and moved upwardly along, closure body channels 64A (FIG. 32) toward the recesses 56A. The as-fabricated (e.g., as-molded) lateral width of the spout base 82A—from one pivot member 84A to the other pivot member 84A—is slightly larger than the space defined in the closure body enclosure 50A between the bottoms of the two vertical channels 64A. However, there is sufficient flexibility in the spout base 82A and/or in the portions of the enclosure 50A defining the channels 64A so as to accommodate temporary, elastic deformation of the spout base 82A and/or enclosure 50A by an amount sufficient to permit the spout pivot members 84A to enter into, and slide along, the vertical channels 64A. When the pivot members 84A are received in the recesses 56A at the top of the channels 64A, the inherent resiliency of the material of the spout 34A and/or of the enclosure 50A permit the pivot members 84A to be received in a snap-fit engagement in the recesses 56A to accommodate pivoting movement of the spout 34A between the substantially vertical dispensing position (FIG. 27) and the retracted, non-dispensing position (FIG. 26).

With reference to FIG. 30, it will be appreciated that when the spout 34A is in the dispensing position, the spout 34A projects outwardly from the body 30A to locate the dispensing opening 80A at a dispensing location that is further outwardly from the closure body 30A than is the non-dispensing location of the dispensing opening 80A. The outward dispensing location of the opening 80A facilitates the dispensing of the fluent substance and facilitates the user's observation of the discharging fluent substance.

The second embodiment spout base portion 82A and the closure base enclosure 50A may be characterized as having a “ball and socket” arrangement that occludes the spout rear opening when the spout 34A is in either the dispensing position (FIG. 30) or in the non-dispensing position (FIG. 29)—even when the lid 32A is open.

As can be seen in FIGS. 34-36, the spout base 82A includes a piercing element, piercing edge, or piercing member 92A. In the preferred embodiment, the piercing edge 92A has a converging or, V-shaped, structure and includes a piercing point 93A, channels 94A, and teeth 94A (FIG. 34).

When the spout 34A is pivoted to the dispensing position (FIG. 30), the pivoting of the spout 34A to the dispensing position causes the spout bottom piercing point 93A and piercing edge 92A to pierce (e.g., puncture, penetrate, tear, cut open, etc.) the membrane 28A and create two, downwardly extending membrane flaps 106A.

The opening in the membrane 28A formed by the piercing member 92A permits the contents of the container 22A to flow into the closure 20A and out of the spout 34A—typically when the user inverts the package (consisting of the container 22A and closure 20A) for dispensing the fluent product with the assistance of gravity, typically while the user is also squeezing the container 22A (if the container is of the squeezable type).

In the second embodiment of the closure 20A, the spout 34A does not contain any valve (such as the valve 36 in the first embodiment (see FIG. 10)). However, if desired, the spout 34A could be provided with a valve located near the distal end of the spout 34A adjacent the dispensing opening 80A in the same manner as in the first embodiment.

As can be seen in FIG. 28, the body 30A includes a deck 40A, and a skirt 44A extends downwardly from the periphery of the deck 40A. The interior of the skirt 44A defines an internal, female thread 46 for threadingly engaging the container neck external, male thread 29A when the dispensing closure body 30A is installed on the container neck 26A.

As can be seen in FIG. 33, the inside of the skirt 44A also has flexible pawl-like teeth 48A for engaging the container neck ratchet teeth 24A (FIG. 31) to prevent unscrewing of the closure. The closure teeth 48A are, however, flexible enough to bend in the radially outward direction and permit the closure to be initially screwed onto the container.

As can be seen in FIG. 28, a “crab's claw” type seal 49A extends downwardly from the underside of the closure body deck 40A to seal against the membrane 28A on the top of the container neck 26A.

As can be seen in FIGS. 25 and 28, the lid 32A includes a receiving region or a pocket 200A for receiving the distal, front end of the spout 34A when the spout 34A is in the retracted, non-dispensing position and the lid 32A is closed. The bottom of the pocket 200A has a laterally extending surface 202A (FIGS. 28 and 33) which is received under the bottom of the front end of the spout 34A when the spout 34A is in the retracted, non-dispensing position. The surface 202A helps initially lift the front, distal end of the spout 34A upwardly as the lid 32A is opened. To this end, a finger or thumb ledge 208A (FIG. 28) is provided at the front, upper portion of the lid 32A.

To assist in opening of the closure, the lid 32A includes two hinges—the primary hinge 31A (FIG. 33) which attaches the lid 32A to the closure body 30A, and a secondary hinge 212A (FIGS. 28, 29, and 33). The part of the lid 32A between the primary hinge 31A and the secondary hinge 212A may be characterized as a rear portion of the lid 32A, while the portion of the lid forward of the hinge 212A may be characterized as the front portion of the lid. The secondary hinge 212A is a film hinge or floppy hinge that permits a front portion of the lid 32A to pivot somewhat relative to the rear portion of the lid 32A so as to accommodate (1) disengagement of the lid 32A from the front of the spout 34A as the lid 32A is opened, and (2) re-engagement of the lid pocket 200A around the spout distal end when the lid 32A is closed.

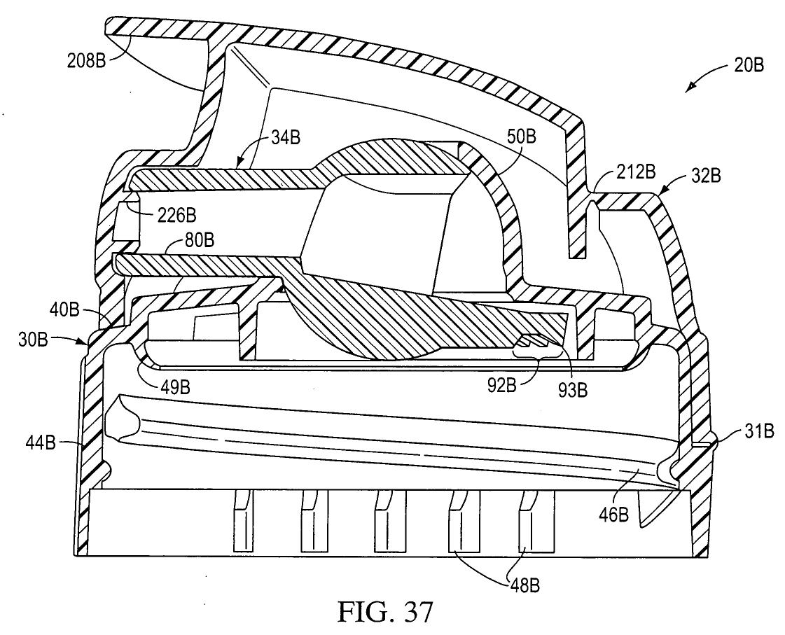

FIG. 37 illustrates the third embodiment of the closure wherein the closure is designated by the reference number 20B. The closure 20B is similar to the second embodiment closure 20A described above. However, in the third embodiment closure 20B, the front of the lid 32B includes a spud 226B which is received in the distal, open end 80B of the spout 34B when the spout 34B is in the retracted, non-dispensing position and the lid 32B is closed. This arrangement seals the distal end of the spout 34B. Either or both of the front of the lid 32B and the front end of the spout 34B are sufficiently flexible to accommodate a temporary elastic deformation as necessary for the spud 226B to be received in, and removed from, the spout open end 80B. It will be appreciated that the rear end of the spout is enclosed and protected by the closure body enclosure 50B in all positions of the spout 34B.

The other features of the third embodiment of the closure 20B are identical or substantially identical with the corresponding features of the second embodiment of the closure 20A discussed above with reference to FIGS. 25-36. In FIG. 37, various features of the third embodiment of the closure 20B are identified with reference numbers followed by the suffix letter “B,” and those identified features designated by those reference numbers correspond with the second embodiment features indicated by the same reference numbers but followed by the suffix letter “A,” and a detailed description of such third embodiment features is not required here.

It will be readily observed from the foregoing detailed description of the invention and from the illustrations thereof that numerous other variations and modifications may be effected without departing from the true spirit and scope of the novel concepts or principles of this invention.

What is claimed is:

1. A dispensing closure system for a container that has an opening to the container interior where a fluent substance may be stored, and wherein a membrane is interposed between the container and dispensing closure system, said dispensing closure system comprising:
(A) a body for extending from said container at said container opening, said closure body having (1) a hollow base for extending outwardly from said container, (2) a deck at the top of said base, and (3) an enclosure that projects outwardly from said deck, and that defines an opening;
(B) a movable spout that (1) has a dispensing opening at one end, (2) has a piercing edge at the other end wherein said piercing edge includes a projecting piercing point, and (3) is mounted in said enclosure for pivoting movement in said enclosure between (a) a non-dispensing position generally parallel to, and above, said membrane to locate said spout dispensing opening at a non-dispensing location, and (b) a dispensing position in which (i) said piercing edge can pierce said membrane, and (ii) said spout projects outwardly from said enclosure to locate said spout dispensing opening at a dispensing location that is further outwardly than said non-dispensing location of said spout dispensing opening; and
a lid hingedly attached to said body for moving between (1) a closed position on top of said body over said enclosure when said spout is in said non-dispensing position, and (2) an open position in which the top of said enclosure is exposed.

2. The closure system in accordance with claim 1 in which
said spout defines a discharge passage; and
said system further includes a dispensing valve that (1) is mounted in said spout, (2) comprises a flexible, resilient material, and (3) has a valve head defining at least one normally closed dispensing orifice which opens to permit flow therethrough in response to a pressure differential across said valve, said valve being disposed in said spout discharge passage to locate said valve adjacent the distal end of said spout.

3. A dispensing closure system for a container that has an opening to the container interior where a fluent substance may be stored, and wherein a membrane is interposed between the container and dispensing closure system, said dispensing closure system comprising:
(A) a body for extending from said container at said container opening; and
(B) a movable spout that (1) has a dispensing opening at one end, (2) has a piercing edge at the other end, and (3) is mounted in said body for pivoting movement between (a) a non-dispensing position in which said piercing edge is above said membrane and said spout dispensing opening is at a non-dispensing location, and (b) a dispensing position in which (i) said piercing edge can pierce said membrane, and (ii) said spout projects outwardly from said body to locate said spout dispensing opening at a dispensing location that is further outwardly than said non-dispensing location of said spout dispensing opening.

4. The closure system in accordance with claim 3 in which
(A) said dispensing closure system body is initially separate from, but releasably attachable to, said container around said container opening; and
(B) said dispensing closure system is adapted for use with said membrane having the form of a liner sealed to the container.

5. The closure system in accordance with claim 3 in which
(A) said dispensing closure system body is initially separate from, but subsequently attachable to, the container around said container opening; and
(B) said dispensing closure system is adapted for use with said membrane in the form of a liner that can be initially sealed to said closure body before said closure body is attached to said container.

6. The closure system in accordance with claim 3 in which said spout is pivotally mounted in said closure body for rotation about an axis.

7. The closure system in accordance with claim 3 in which said spout has a generally tubular configuration.

8. The closure system in accordance with claim 3 in which said body includes an enclosure in which at least part of said spout is disposed at least when said spout is in said non-dispensing position.

9. The closure system in accordance with claim 3 further including a lid and at least a first hinge for hingedly attaching said lid to said body for accommodating movement of said lid between (1) a closed position on top of said body, and (2) an open position in which the top of said body is exposed.

10. The closure system in accordance with claim 9 in which said lid includes a second hinge connecting a rear portion of the lid with a front portion of said lid so that the front portion of said lid can pivot relative to the rear portion of said lid during opening and closing of said lid.

11. The closure system in accordance with claim 9 in which said lid includes (1) a recess for receiving said one end of said spout, and (2) a spud in said recess for occluding said dispensing opening of said spout when said spout is in said non-dispensing position.

12. The closure system in accordance with claim 9 in which said closure lid includes a recess for receiving said one end of said spout, and said lid has a laterally extending surface at the bottom of said recess for engaging a portion of said spout to lift said one end of said spout when said lid is lifted toward said open position.

13. The closure system in accordance with claim 3 in which
said spout defines a discharge passage; and
said system further includes a dispensing valve that (1) is mounted in said spout, (2) comprises a flexible, resilient material, and (3) has a valve head defining at least one normally closed dispensing orifice which opens to permit flow therethrough in response to a pressure differential across said valve, said valve being disposed in said spout discharge passage to locate said valve adjacent the distal end of said spout.

14. The closure system in accordance with claim 13 in which
said valve dispensing orifice is defined by a plurality of slits that extend (1) through said valve head from an exterior side to an interior side, and (2) laterally from a common origin so that petals are defined by said slits whereby said orifice is capable of opening by outward deflection of said petals when the pressure in the interior of said valve exceeds the pressure on the exterior of said valve by a predetermined amount;
said slits are each generally planar;
said slits are of equal length; and
said slits define equal size petals.

15. The closure system in accordance with claim 12 in which
said valve is a self-closing valve;
said valve opens outwardly when the pressure against the side of said valve facing the interior of the container exceeds the pressure acting against the side of said valve exposed to ambient atmosphere by a predetermined amount; and
said valve returns from an open condition to a closed condition after the pressure acting on the side of the valve facing the interior of the container decreases sufficiently.

16. The closure system in accordance with claim 12 in which
said valve has an annular flange;
said spout defines a generally annular seat facing generally away from the distal end of said spout; and
said closure system further includes a retaining ring having a portion engaged with said spout to retain said valve in said spout wherein said valve annular flange is clamped by said retaining ring against said seat in said spout.

17. The closure system in accordance with claim 16 in which
said retaining ring is in a snap-fit engagement with said spout;
said valve annular flange has a dovetail cross section defining a frustoconical outer surface and a frustoconical inner surface;
said spout seat is a frustoconical surface engaging said frustoconical outer surface of said valve annular flange; and
said retaining ring has a frustoconical clamping surface engaging said frustoconical inner surface of said valve annular flange to clamp said valve annular flange between said retaining ring and said spout seat.

18. The closure system in accordance with claim 3 for use with a container that has an annular top end defining (1) an opening occluded by said membrane in the form of a liner sealed to said annular top end, and (2) an external, male thread around said opening, and in which
said closure system is a dispensing closure that is separate from, but releasably attachable to, said container around said container opening;
said closure body has a hollow, generally cylindrical base which has an internal, female thread for threadingly engaging said male thread on said container;
said body includes a deck at the top of said base and an enclosure on top of said deck; and
said spout extends outwardly beyond said enclosure when said spout is in said dispensing position.

19. The closure system in accordance with claim 3 in which said piercing edge includes a piercing point defined by three converging surfaces.

20. The closure system in accordance with claim 3 in which said spout includes a retention bead for engaging said body to releasably hold said spout in said dispensing position.
